(19) United States
(12) Patent Application Publication
(10) Pub. No.: US 2012/0161962 A1
(43) Pub. Date: Jun. 28, 2012

(54) Service providing method, information processing apparatus and computer readable information recording medium

(75) Inventors: Takeshi Sano, Kawasaki (JP); Kazuo Sasaki, Kawasaki (JP)

(73) Assignee: FUJITSU LIMITED, Kawasaki (JP)

(21) Appl. No.: 13/200,356

(22) Filed: Sep. 23, 2011

(30) Foreign Application Priority Data
Dec. 28, 2010 (JP) 2010-294286

(51) Int. Cl. G08B 1/08

(52) U.S. Cl. 340/539.13

(57) ABSTRACT

A service providing method of being notified of position information by terminals and providing services corresponding to the notified position information of the terminals includes determining movements of the terminals based on the notified position information; in a case where it has been determined that a difference between the movements of the terminals is equal to or less than a threshold, storing information indicating the determined terminals in an associating information database in a manner of being associated with each other; transmitting signals indicating notification modes of reduced notification frequencies of the position information to the associated terminals; and when the position information is notified by one of the associated terminals, using the notified position information as the position information of the one of the associated terminals and also as the position information of another one of the associated terminals.

### CROSS-REFERENCE TO RELATED APPLICATION

This application is based upon and claims the benefit of priority of the prior Japanese Patent Application No. 2010-294286, filed on Dec. 28, 2010, the entire contents of which are incorporated herein by reference.

### FIELD

The embodiments discussed herein relate to a service providing method, an information processing apparatus and a computer readable information recording medium.

### BACKGROUND

A technique is known where simple map data is stored in an information providing apparatus, and in the simple map data, information transmission determination information is attached to each of plural unit areas. The information transmission determination information indicates whether the unit area is an information transmission area (where a portable terminal will transmit position information) or an information not-transmission area (where the portable terminal will not transmit the position information). In this technique, the portable terminal compares the simple map data and its own position, and the portable terminal transmits the position information in a case where the portable terminal lies within the information transmission area. On the other hand, in a case where the portable terminal lies within the information not-transmission area, the portable terminal is prevented from transmitting the position information.

Further, a technique of “automatic GPS” is known where a position of a portable terminal is periodically measured, and information of the measured position (position information) is provided to a service providing party.

### PRIOR ART DOCUMENTS

Patent Document 1:

Japanese Laid-Open Patent Publication No. 2009-88775

Non-Patent Document 1:

11 “NTT docomo, automatic GPS” (URL: http://www.nttdocomo.co.jp/service/information/auto_gps/)

Non-Patent Document 2:

“NTT docomo, automatic GPS associated functions” (URL: http://www.nttdocomo.co.jp/service/customize/iconcie r/auto_gps/)

### SUMMARY

According to one aspect of the present disclosure, an information processing apparatus determines movements of terminals based on position information notified by the terminals, and, in a case of having determined that a difference between the movements of the terminals is equal to or less than a threshold, the information processing apparatus stores information indicating the determined terminals in an associating information DB in such a manner of being associated with each other. The information processing apparatus transmits, to the associated terminals, signals indicating notification modes of reduced notification frequencies. When receiving the position information notified by one of the associated terminals, the information processing apparatus uses the position information notified by one of the associated terminals as the position information of the one of the associated terminals. Further, the information processing apparatus uses the position information notified by the one of the associated terminals also as the position information of another one of the associated terminals.

### BRIEF DESCRIPTION OF DRAWINGS

FIG. 1 depicts one example of respective configurations of hardware of a terminal and a server included in an information processing system which realizes a service providing method according to an embodiment 1;

FIG. 2 is a functional block diagram depicting one example of the terminal and the server included in the information processing apparatus depicted in FIG. 1;

FIG. 3 is a flowchart depicting one example of a flow of a process for receiving position information in the service providing method according to the embodiment 1;

FIG. 4 is a flowchart depicting one example of a flow of an associating process and an accompanying cancellation forecast process in the service providing method according to the embodiment 1;

FIG. 5 is a flowchart depicting one example of a flow of an accompanying cancellation determination process in the service providing method according to the embodiment 1;

FIG. 6 is a flowchart depicting one example of a flow of a branch point extraction process in the service providing method according to the embodiment 1;

FIG. 7 is a sequence diagram depicting one example of a flow of an accompanying determination process in the service providing method according to the embodiment 1;

FIG. 8 depicts one example of a position information notification message in the service providing method according to the embodiment 1;

FIG. 9 depicts one example of a notification timing message in the service providing method according to the embodiment 1;

FIG. 10 is a sequence diagram depicting another example of a flow of the accompanying determination process in the service providing method according to the embodiment 1;

FIG. 11 is a sequence diagram depicting one example of a flow of a position information notification process at a time of accompanying together in the service providing method according to the embodiment 1;

FIG. 12 is a sequence diagram depicting one example of a flow of a branch point extracting process applicable to the service providing method according to the embodiment 1;

FIG. 13 illustrates a branch point extracting process applicable to the service providing method according to the embodiment 1;

FIG. 14 is a sequence diagram depicting one example of a flow of an accompanying cancellation forecast process in the service providing method according to the embodiment 1;

FIG. 15 depicts one example of an accompanying cancellation forecast notification message in the service providing method according to the embodiment 1;

FIG. 16 is a sequence diagram depicting one example of a flow of an accompanying cancellation determination process in the service providing method according to the embodiment 1;

FIG. 17 depicts one example of an accompanying-cancellation-determination position information notification message in the service providing method according to the embodiment 1;

FIG. 18 is a sequence diagram depicting another example of a flow of an accompanying cancellation determination process in the service providing method according to the embodiment 1;

FIG. 19 depicts one example of a notification timing message at a time of returning a notification interval to an original one in the service providing method according to the embodiment 1;

FIG. 20A illustrates one example of calculation of notification timing in the service providing method according to the embodiment 1;

FIG. 20B illustrates another example of calculation of notification timing in the service providing method according to the embodiment 1;

FIG. 20C is a flowchart depicting one example of a notification timing determination method in the service providing method according to the embodiment 1;

FIG. 21 depicts one example of a position information notification message in a service providing method according to an embodiment 2;

FIG. 22A illustrates one example of calculation of notification timing in the service providing method according to the embodiment 2; and

FIG. 22B is a flowchart depicting one example of a notification timing determination method in the service providing method according to the embodiment 2.

### DESCRIPTION OF EMBODIMENTS

According to embodiments of the present invention, in a service providing method where an information processing apparatus receives position information notified by a terminal and provides a service corresponding to the position information notified by the terminal, it is possible to efficiently reduce a power consumption in the terminal.

Below, the service providing methods according to the embodiments of the present invention will be described.

### [Embodiment 1]

According to the service providing method in the embodiment 1, a server which provides a service is notified of position information indicating a position of a terminal such as a cellular phone by the terminal, and provides the service corresponding to the notified position information to the terminal. Further, according to the service providing method in the embodiment 1, when the terminal notifies the server of the position information, in a case where the terminals are determined as accompanying together, the server uses the position information as being common to the terminals determined as accompanying together. Using the position information as being common to the terminals determined as accompanying together will now be described.

That is, when one terminal of plural terminals determined as accompanying together notifies the server of the position information, the server uses the notified position information as the position information of the one terminal, and also, uses the same position information also as the position information of another terminal of the plural terminals. To use the common position information for respective ones of the plural terminals determined as accompanying together by the server will be referred to as “to use the position information as being common”.

According to the service providing method in embodiment 1, by using the position information as being common to the terminals determined as accompanying together, it is possible to reduce the frequency of notifying the server of the position information by the respective terminals. The frequency of notifying means an average number of times of notifying within a certain period of time, and may also be referred to as a notification frequency. As a result of thus reducing the notification frequency, it is possible to effectively reduce power consumption of each terminal, and also, it is possible to effectively reduce a load of each terminal to measure its own position to obtain the position information. It is noted that an interval(s) at which the terminal notifies the position information may be simply referred to as a notification interval(s), and a timing(s) at which the terminal notifies the position information may be simply referred to as a notification timing(s).

Below, a system will be described where a server that provides a service is notified of position information indicating a position of a terminal such as a cellular phone by the terminal, and the server provides the service corresponding to the notified position information. In the system, the terminal uses a GPS (Global Positioning System) function and obtain the position information that is information of the own position, and notifies the server of the position information. The server receives the notification, and provides the service corresponding to the position information. Specifically, for example, according to the position of the terminal, information introducing recommended restaurants or shops near the position may be provided to the terminal, or information of a last train may be provided to the terminal according to the position of the terminal and according to the current time.

In such a system, each terminal periodically obtains its own position and transmits the position information to the server. In this case, power is consumed for the respective operations of obtaining its own position and transmitting the position information, and also, a load of the communication network increases when the terminal transmits the position information to the server. On the other hand, in a case where the notification frequency is reduced for the purpose of reducing the power consumption and the load of the communication network, there may be a likelihood that appropriate services are not be provided.

According to the embodiment 1, the server obtains a movement path of each terminal from the position information notified by the terminal, and detects that the plural terminals are accompanying together, using the obtained movement paths, for example. It is noted that terminals determined as accompanying together may be refereed to as mutually accompanying terminals, or simply accompanying terminals.

When detecting that plural terminals are accompanying together, the server manages the mutually accompanying terminals in a manner of associating the terminals with each other.

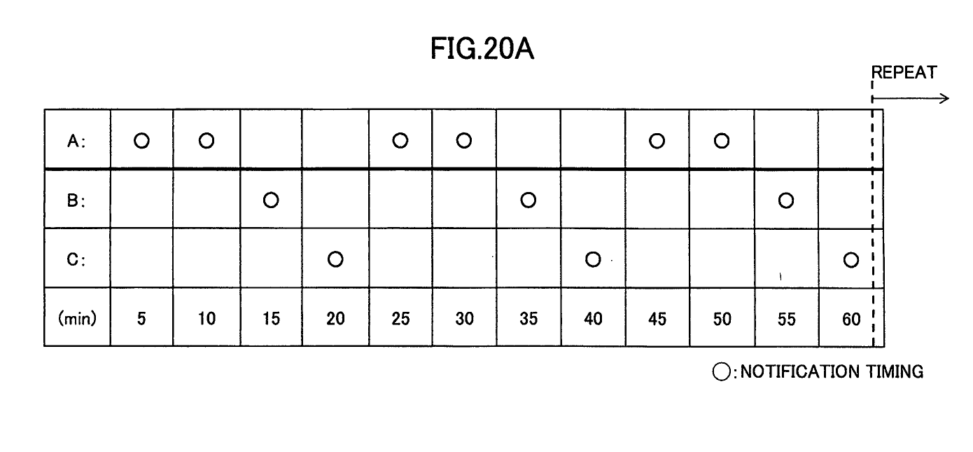

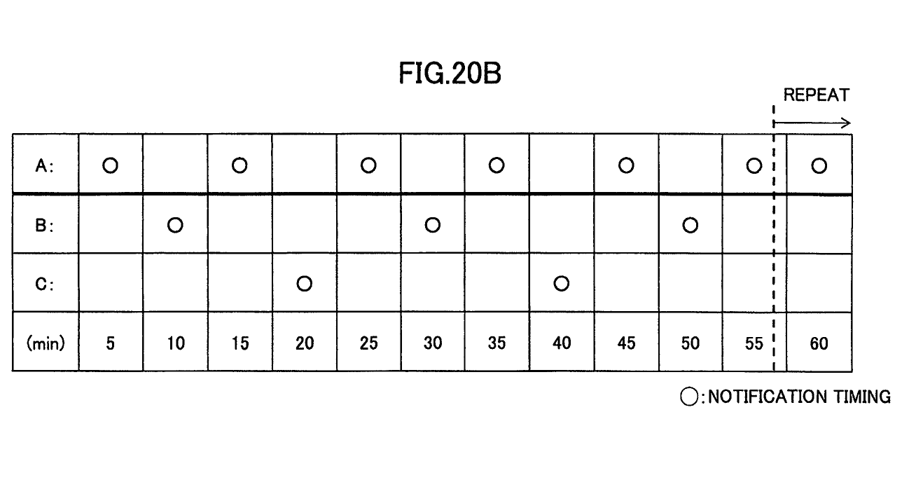

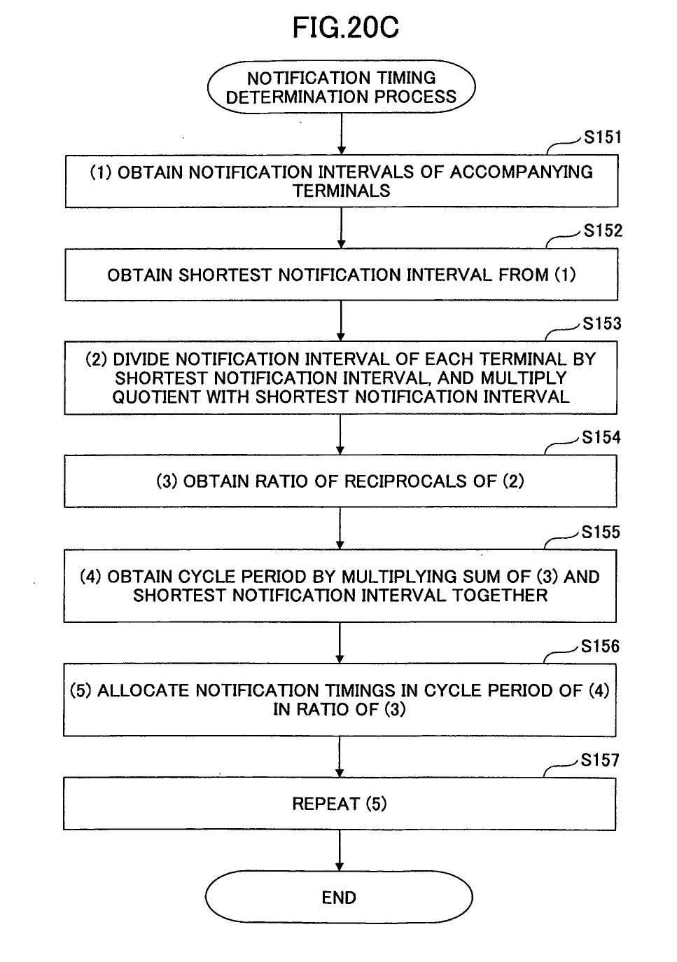

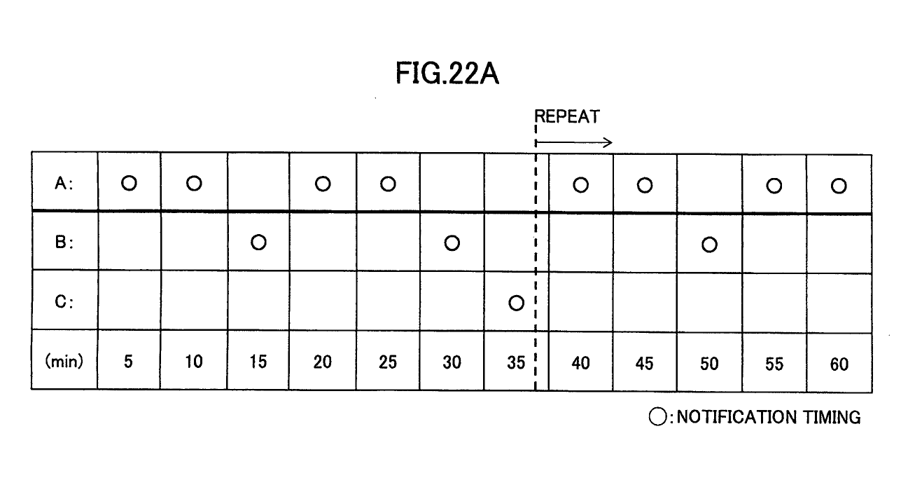

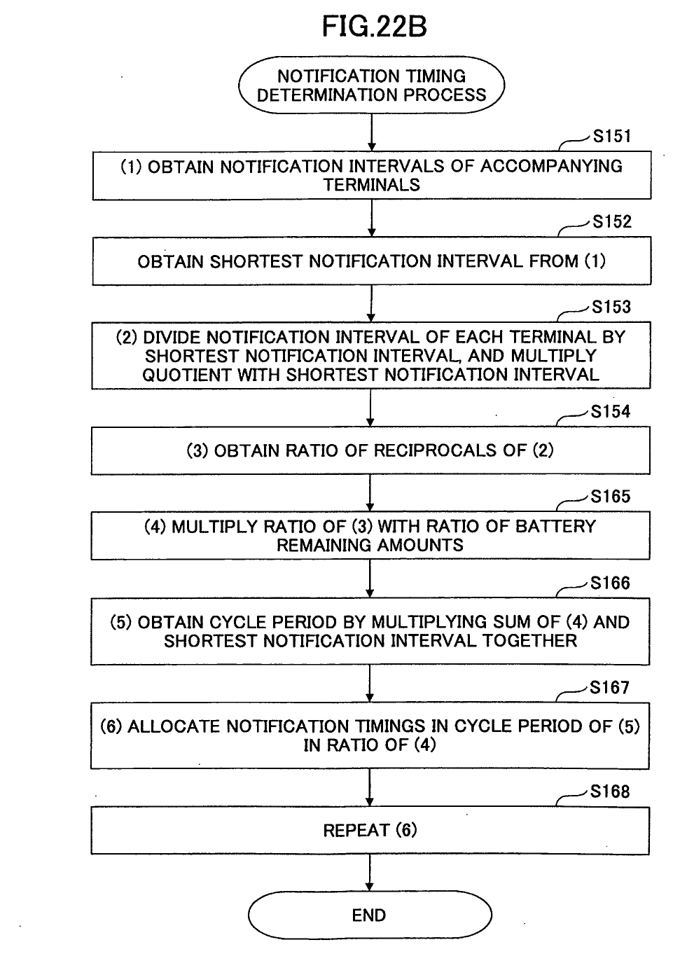

Based on the notifying interval(s) of notifying the position information by each terminal (in an embodiment 2 described later, based on the notification interval(s) and a battery remaining amount), the server calculates notification timings of notifying the position information for the respective terminals such that the number of terminals which notify the position information simultaneously among the mutually accompanying terminals is one (see FIGS. 20A, 20B and 22A described later). The server transmits the calculated notification timings of notifying the position information to the corresponding terminals, respectively. The terminals obtain their own positions at the received notification timings and notify the server of their obtained position information, respectively. When receiving the position information notified by the respective terminals, the server uses the position information as being common to the mutually accompanying terminals.

Thus, according to the embodiment 1, by using the position information as being common to the mutually accompanying terminals, it is possible to use the position information notified by one of the mutually accompanying terminals also as the position information of the other terminals. As a result, the server obtains the position information at intervals of time the same as the notification intervals at which the respective terminals have notified the position information before receiving and using the above-mentioned notification timings, even when the notification frequencies at which the respective terminals notify their position information are reduced as a result of the server transmitting the notification timings of reducing the notification frequencies to the respective terminals. Therefore, it is possible to reduce the power consumption of each terminal, and also, reduce the load of the communication network. Further, the server determines whether the terminals are accompanying together only using the position information notified by the respective terminals without using sensor information or terminal information. Therefore, the server does not have the load of collecting the sensor information or terminal information. The determination as to whether the terminals are accompanying together may be referred to as a determination of accompanying terminals.

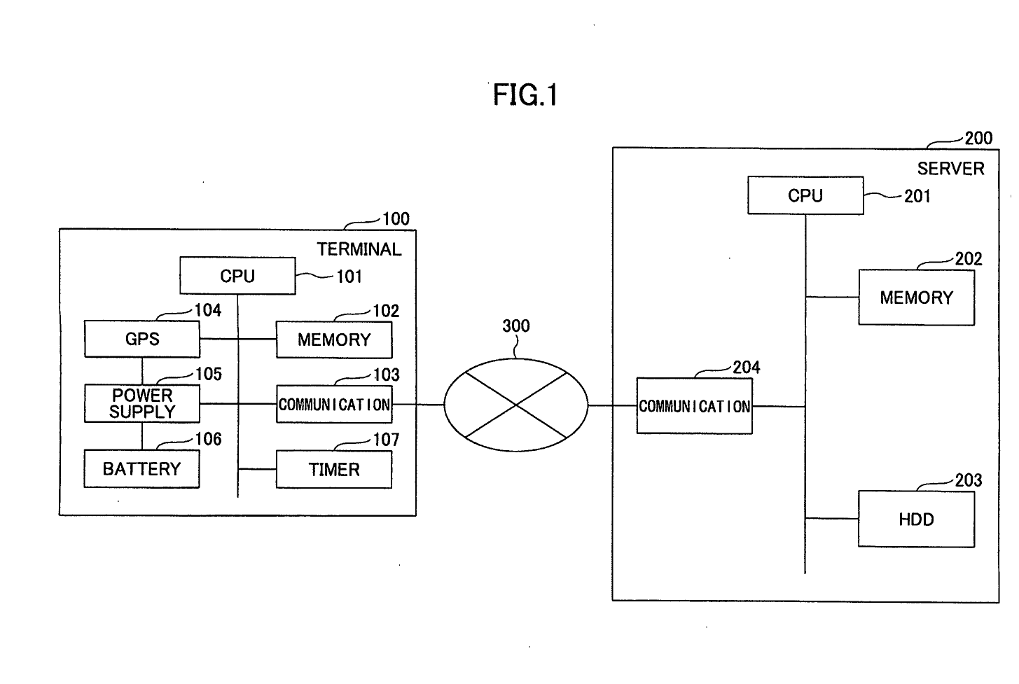

With reference to FIG. 1, one example of a system embodying the service providing method according to the embodiment 1 will now be described.

As depicted in FIG. 1, the system includes a server 200 and a terminal 100. It is noted that for the sake of convenience of explanation, the only one terminal 100 is depicted. However, actually, the system includes many terminals, and each of the terminals has the same configuration and functions as those of the terminal 100.

The server 200 and the terminal 100 are connected by a radio communication network 300 as being able to carry out radio communication therebetween.

The terminal 100 is, for example, a cellular phone, a portable information terminal, a notebook-type personal computer, or such, and includes a CPU (Central Processing Unit) 101, a memory 102, a communication part 103, a GPS part 104, a power supply part 105, a battery 106 and a timer 107.

The CPU 101 controls operations of the entirety of the terminal 100, and also, carries out various arithmetic and logic operations. The memory 102 stores programs and data. The CPU 101 executes a program stored by the memory 102, to control operations of the terminal 100 and carry out various arithmetic and logic operations. Further, the memory 102 provides a working area for the CPU 101.

The communication part 103 includes a modem (modulator and demodulator) and so forth, and carries out radio communication with the server 200 via the radio communication network 300. The communication part 103 carries out radio communication with a GPS satellite (not depicted), and provides a signal received from the GPS satellite to the GPS part 104.

The GPS part 104 determines the position of the terminal 100 based on the signal received from the GPS satellite provided by the communication part 103, and notifies the server 200 of the position information via the communication part 103.

The power supply part 105 supplies power supplied by the battery 106 to respective parts of the terminal 100 including the GPS part 104 (in the embodiment 2 described above, information of the battery remaining amount of the battery 106 is notified to the server 200 via the communication part 103).

The timer 107 measures the notification timings of notifying the position information to the server 200 from the terminal 100.

The server 200 includes a CPU 201, a memory 102, a hard disk drive 203 and a communication part 204.

The CPU 201 controls operations of the entirety of the server 200, and also, carries out various arithmetic and logic operations. The memory 202 stores programs and data. The CPU 2101 executes a program stored by the memory 202, to control operations of the server 200 and carry out various arithmetic and logic operations. Further, the memory 202 provides a working area for the CPU 201.

The communication part 203 includes a modem (modulator and demodulator) and so forth, and carries out radio communication with the terminal 100 via the radio communication network 300.

The server 200 is notified of the position information by the terminal 100, and provides a service corresponding to the notified position information to the terminal. For example, the server 200 is notified of the position information by the terminal 100, and provides information corresponding to the notified position information to the terminal 100. It is noted that for example, in the server 200, the CPU 201 may execute a program stored by the memory 202, and thus, carry out the following operations. That is, the information to be provided corresponding to the position information notified by the terminal 100 is read from information that is previously stored in the hard disk drive 203, and is provided to the terminal 100. Further, as another example, in the server 200, the CPU 201 may execute a program stored by the memory 202, and thus, carry out the following operations. That is, the information to be provided to the terminal 100 is stored or prepared by an information providing server or such (not depicted) which is provided separately from the server 200. Then, the server 200 transfers the position information notified by the terminal 100 to the information providing server or such, and provides the information provided by the information providing server or such in response to the position information to the terminal 100. The information to be provided to the terminal 100 by the server 200, the information providing server, a content server or such, may be, for example, the above-mentioned information introducing restaurant or shops recommended concerning the notified position of the terminal 100, information of the last train provided according to the notified position of the terminal 100 and the current time, or such.

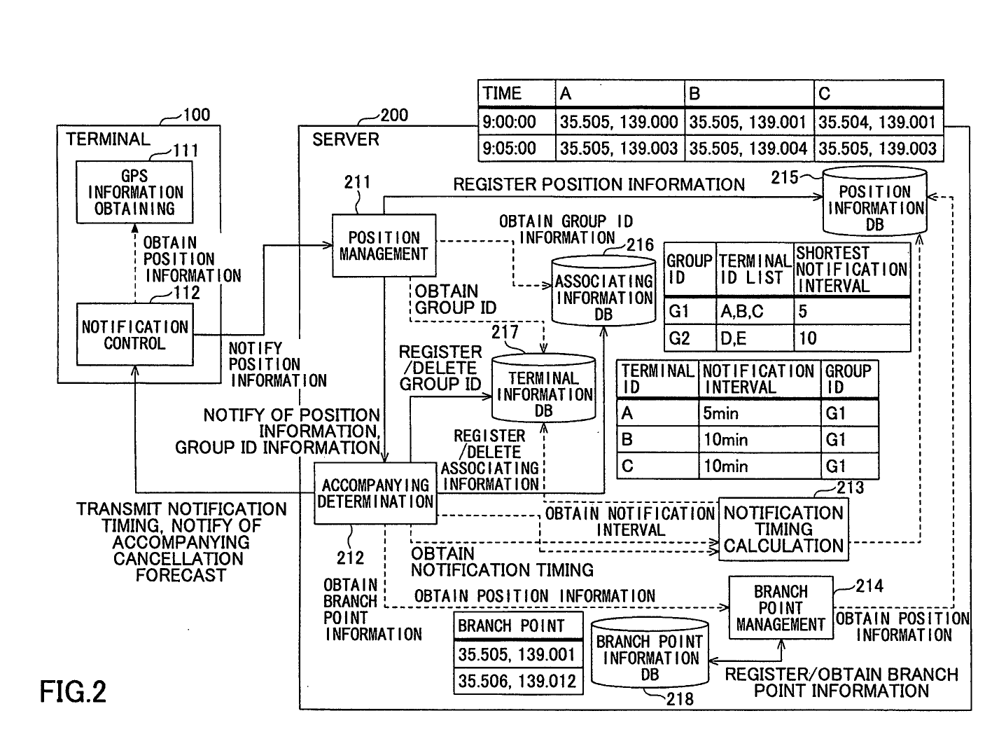

With reference to FIGS. 2 through 20C, functions of the respective ones of the server 200 and the terminal 100 will now be described in detail.

FIG. 2 depicts one example of functional block configurations of the server 200 and the terminal 100.

As depicted in FIG. 2, the terminal 100 includes a GPS information obtaining part 111 and a notification control part 112. The GPS information obtaining part 111 and the notification control part 112 are realized as a result of the CPU 101 depicted in FIG. 1 executing a program stored by the memory 102, and using the memory 102, the communication part 103, the GPS part 104 and the timer 107.

The GPS information obtaining part 111 obtains the position information of the terminal 100 provided by the GPS part 104 and sends the position information to the notification control part 112.

The server 200 includes a position management part 211, an accompanying determination part 212, a notification timing calculation part 213, a branch point management part 214, a position information DB (database) 215, an associating information DB 216, a terminal information DB 217 and a branch point information DB 218.

The position management part 211, the accompanying determination part 212, the notification timing calculation part 213 and the branch point management part 214 are realized as a result of the CPU 201 depicted in FIG. 1 executing a program stored by the memory 202, and using the memory 202, the hard disk drive 203 and the communication part 204.

The position information DB (database) 215, the associating information DB 216, the terminal information DB 217 and the branch point information DB 218 are realized as a result of the CPU 201 depicted in FIG. 1 executing a program stored by the memory 202, and using data stored by the hard disk drive 203 and so forth.

The position management part 211 receives the position information transmitted by the communication control part 112 of the terminal 100, and registers the position information in the position information DB 215. The accompanying determination part 212 carries out a determination of accompanying terminals (accompanying determination process). The determination of accompanying terminals is carried out based on the position information of the respective terminals stored in the position information DB 215. Further, the accompanying determination part 212 also carries out an accompanying cancellation determination process described later. The accompanying cancellation determination process is a determination as to whether an accompanying state of the accompanying terminals has been cancelled, and is carried out based on the position information of the respective terminals stored by the position information DB 215.

The notification timing calculation part 213 calculates the notification timings of the accompanying terminals, and transmits the calculated notification timings to the corresponding terminals 100 respectively via the accompanying determination part 212. The calculation of the notification timings is carried out based on the notification intervals of the accompanying terminals (in the embodiment 2 described later, the notification intervals and the battery remaining amounts).

The branch point management part 214 manages branch point information based on the position information stored by the position information DB 215 using the branch point information DB 218. The branch point information is information indicating positions (branch points) at which there are likelihoods that accompanying states of accompanying terminals are cancelled. The positions (branch points) at which there are likelihoods that accompanying states of accompanying terminals are cancelled means positions of points (branch points) at which paths of the respective terminals generated from histories of the position information of the respective terminals branch or separate. For example, the branch points coincide with branch points or intersections of roads. First of all, the paths of the respective terminals are obtained from the histories of the position information of the respective terminals. The paths of the respective terminals mean paths in which the respective terminals have moved. For example, in the history data, an end point of part in which the paths of plural terminals coincide with each other (which paths may be those occurring at mutually different times), i.e., a point at which after a state where the paths of the plural terminals coincide with each other continues, the paths separate from each other is a branch point.

The position information DB 215 stores the position information of the respective terminals at every time. FIG. 2 depicts, as one example, a state where, as the first record (first line), latitude (139.000, 139.001, 139.001) and longitude (35.505, 35.505, 35.504) of respective ones of the terminals A, B and C at 9 o'clock (9:00:00) are stored. Further, as to the second record (second line), similar information is stored for the time of 9:05 (9:05:00) after the elapse of 5 minutes.

The associating information DB 216 stores a list of accompanying terminals. In the example of FIG. 2, as the first record, a group ID (G1) is attached to the accompanying terminals A, B and C and is stored. Further, 5 [minutes] as a shortest notification interval is stored. The shortest notification interval means the shortest one of notification intervals at which the accompanying terminals notify the position information in a state where the accompanying terminals are not the accompanying terminals (i.e., are not-accompanying terminals), respectively.

The terminal information DB 217 stores information of the respective terminals. In the example of FIG. 2, as the first record, for the terminal A having a terminal ID of “A”, information is stored that the notification interval is “5 min”, and the group ID is “G1”. The notification interval at this time means an interval of notifying the position information in a state where the accompanying terminal is not the accompanying terminal (i.e., is a not-accompanying terminal). It is noted that the notification interval may be freely determined by the user of each terminal, or may be determined from the side of the service to be provided.

The branch point information DB 218 stores the above-mentioned branch point information. In the example of FIG. 2, as the branch point information, information of the positions of latitude 139.001 and longitude 35.505, and latitude 139.012 and longitude 35.506 is stored.

Next, flows of operations of respective processes according to the embodiment 1 will be described.

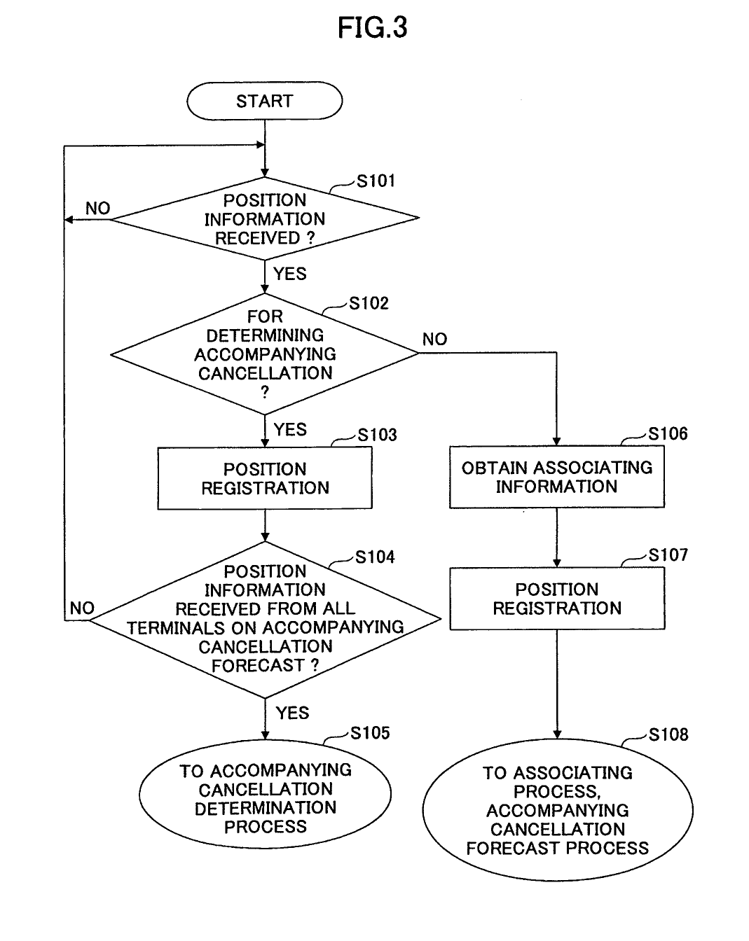

FIG. 3 depicts one example of a flow of operations at a time of the server 200 receiving the position information from the terminal 100.

In FIG. 3, when the server 200 has received the position information from the terminal 100 (step S101 YES), the server determines whether the position information is for the purpose of an accompanying cancellation determination (step S102). On the other hand, when the server 200 has not received the position information (step S101 NO), the server 200 carries out step S101 again.

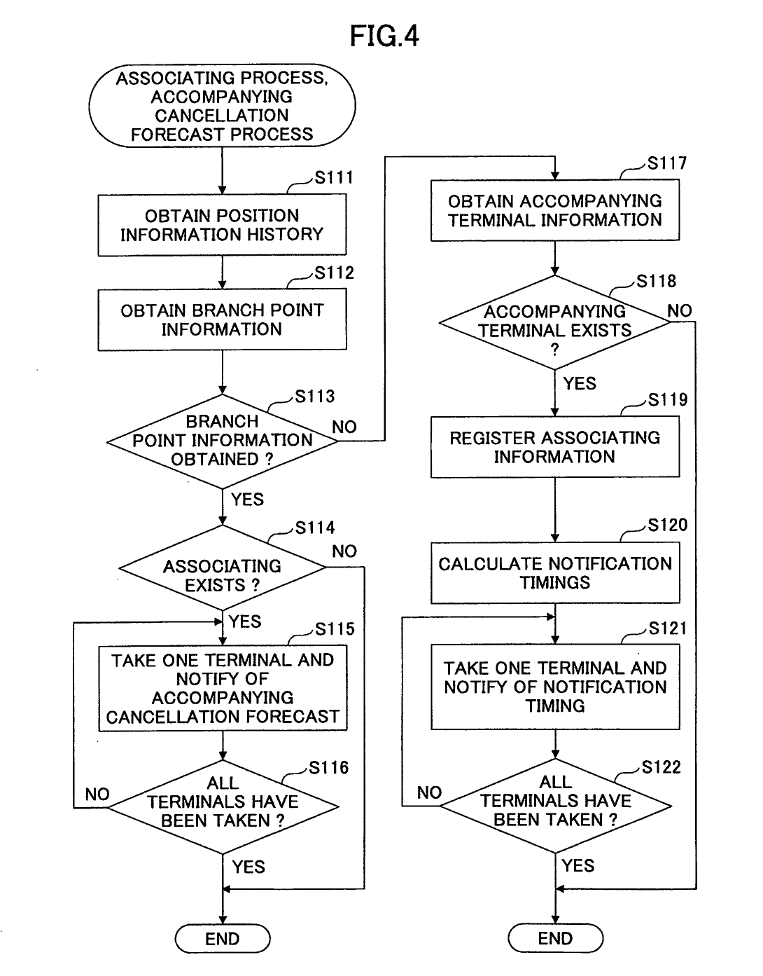

The position information for an accompanying cancellation determination will now be described. The server 200 obtains the branch point information from the branch point information DB 218 in a step of obtaining the branch point information (step S112) depicted in FIG. 4 described below, and the server 200 calculates a time at which it is expected that the accompanying terminal 100 passes through the branch point indicated by the branch point information. Then, the server 200 transmits an accompanying cancellation forecast notification message that directs the terminal 100 to notify the position information at the time after the time at which it is expected that the terminal 100 passes through the branch point to the terminal 100 (step S115 in FIG. 4). The terminal 100 responds to the accompanying cancellation forecast notification message and notifies the position information for an accompanying cancellation determination at the time after the time at which it is expected that the terminal 100 passes through the branch point.

When the received position information is the position information for an accompanying cancellation determination (step S102 YES), the server 200 registers the position information to the position information DB 215 (step S103), and then carries out step S104. On the other hand, when the received position information is not the position information for an accompanying cancellation determination (step S102 NO), then the server 200 carries out step S106.

In step S104, the server 200 determines whether having received the position information from all of the terminals for which the accompanying cancellation forecast is being carried out. All of the terminals for which the accompanying cancellation forecast is being carried out means all the terminals for which there are likelihoods that the accompanying states of the accompanying terminals are cancelled, and means the terminals of transmission destinations to which the server 200 has transmitted the accompanying cancellation forecast notification messages.

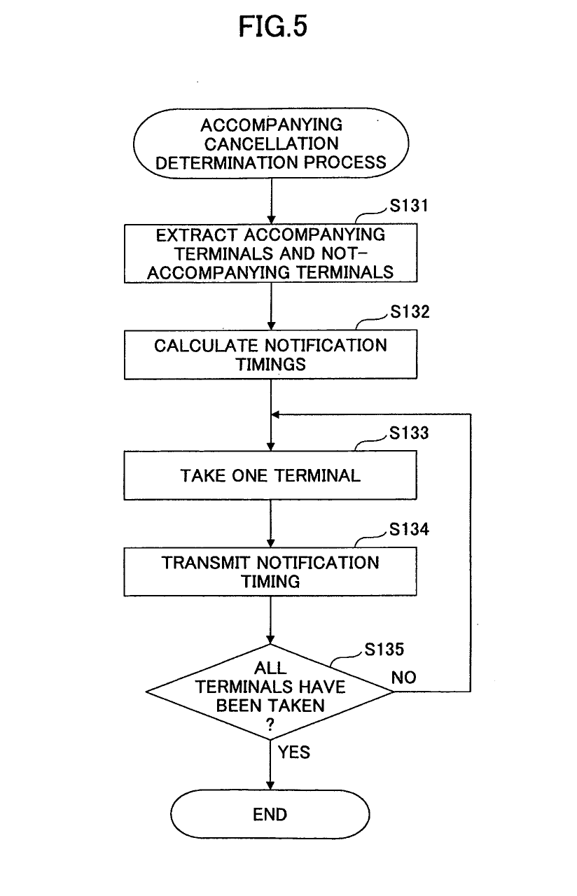

When not having received the position information from all the terminals for which the accompanying cancellation forecast is being carried out (step S104 NO), the server 200 again carries out step S101. When having received the position information from all the terminals for which the accompanying cancellation forecast is being carried out (step S104 YES), the server 200 carries out the accompanying cancellation determination process described later with reference to FIG. 5 (step S105).

In step S106, the server 200 obtains the group ID of the terminal having transmitted the received position information, extracts the information (i.e., associating information) indicating all the terminals having the obtained group ID from the associating information DB 216, and then, carries out step S107. However, in a case where the terminal having transmitted the received position information is not an accompanying terminal, the server 200 then carries out step S107 without carrying out step S106 since the terminal does not have the group ID.

In step S107, in the case where the terminal is not an accompanying terminal, the server 200 registers the received position information for the terminal. On the other hand, in a case where the terminal is an accompanying terminal, the server 200 registers the received position information for the terminal, and also, based on the associating information extracted in step S106, the server 200 registers the position information also for the other accompanying terminals. That is, in the case where the terminal having transmitted the position information received by the server 200 is an accompanying terminal, the other accompanying terminals accompanying the above-mentioned terminal are regarded as having the same position information, and registers the position information having been received from the above-mentioned terminal also for each of the other accompanying terminals. That is, the position information notified by one of the accompanying terminals is obtained as the position information of the one terminal, and also, is obtained the position information as each of the other terminals accompanying the above-mentioned terminal. Next to step S107, an associating process and the accompanying cancellation forecast process described later with reference to FIG. 4 are carried out (step S108).

Next, a flow of operations of the associating process and the accompanying cancellation forecast process will be described with reference to FIG. 4.

First, in step S111, the server 200 obtains from the position information DB 215 a history of the terminal having transmitted the position information received by the server 200.

Next, in step S112, the server 200 obtains a moving speed and a moving direction of the terminal from the obtained history. Then, the server 200 extracts from the branch point information DB 218 the branch point information of the branch point(s) which the terminal is expected to pass through until the subsequent notification timing, based on the moving speed and the moving direction of the terminal and the shortest notification interval of the accompanying terminals included in the associating information obtained in step S106. After that, the server 200 carries out step S113.

In step S113, the server 200 determines whether the branch point information could have been obtained (extracted) in step S112. When the branch point information could have been obtained in step S112 (step S113 YES), the server 200 then carries out step S114, and then, carries out the accompanying cancellation forecast process. On the other hand, when the branch point information could not have been obtained in step S112 (step S113 NO), the server 200 then carries out step S117, and then carries out the associating process including the accompanying determination process.

In step S114, the server 200 determines whether there is the group ID of the terminal having transmitted the received position information, which group ID the server 200 has tried to obtain in step S106, and determines whether there is another terminal associated with the terminal. That is, the server 200 determines whether the terminal is an accompanying terminal. In a case where there is no terminal associated with the terminal (step S114 NO), the process is finished.

On the other hand, in a case where there is a terminal associated with the terminal (step S114 YES), the server 200 extracts an associated terminal, i.e., any one of the terminal having transmitted the position information and all the terminal(s) accompanying the terminal, in step S115. Then, the server 200 transmits the accompanying cancellation forecast notification message to the extracted terminal, and then, carries out step S116.

In step S116, the server 200 determines whether having completed transmitting the accompanying cancellation forecast notification messages to the terminal having transmitted the position information and all the terminals accompanying the terminal. In a case where having completed transmitting the accompanying cancellation forecast notification messages to the terminal having transmitted the position information and all the terminals accompanying the terminal (step S116 YES), the server 200 finishes the process. On the other hand, when not yet having completed transmitting the accompanying cancellation forecast notification messages to the terminal having transmitted the position information and all the terminals accompanying the terminal (step S116 NO), the server 200 carries out step S115 again.

In step S117, the server 200 obtains accompanying terminal information. The accompanying terminal information means information of the terminal(s) accompanying the terminal having transmitted the position information. That is, to obtain accompanying terminal information at this time means to carry out the accompanying determination process. Specifically, the immediately preceding history of the position information of the terminal having transmitted the position information is obtained from the position information DB 215, and the immediately preceding path is obtained from the obtained history of the position information. Then, the position information DB 215 is read, and another terminal having an immediately preceding path identical or approximately identical to the obtained path of the terminal is searched for. The thus-obtained terminal through the search is determined as a terminal being accompanying the terminal having transmitted the position information received by the server 200. Next to step S117, the server 200 carries out step S118.

A method of an accompanying determination (the accompanying determination process) will now be described.

In the case of the embodiment 1, the position information DB 215 is read, and it is determined that two terminals are accompanying together in a case where the two terminals having the same immediately preceding paths exist. Here, having the same immediately preceding paths means, in a case where the position information is obtained at intervals of 5 minutes for example, the distance between two terminals is equal to or less than a certain distance 5 minute ago and the distance between the two terminals is equal to or less than the certain distance also at the present time. That is, movements of two terminals are determined, and it is determined that the two terminals are accompanying together in a case where the movements of the two terminals are equal to or less than a threshold.

As another method of the accompanying determination, it is also possible to determine that two terminals are accompanying together simply in a case where the distance between the terminals is equal to or less than a certain distance (or the distance between the terminals is less than a certain distance). The certain distance may be, for example, 20 m. That is, for example, two terminals may be determined as accompanying together when the distance between the two terminals is less than 20 m.

Further, in a case of equal to or more than three terminals, it is possible to determine these terminals as accompanying together in a case where two terminals of each of all of the combinations of two terminals that may be extracted from these terminals are determined as accompanying together (the same method may be applied hereinafter).

Alternatively, it is also possible to determine two terminals are accompanying together in a case where the two terminals have the distance therebetween equal to or less than a certain distance for equal to or more than a certain period of time.

Alternatively, it is also possible to determine whether accompanying exists by using a different logic depending on a state of movements of terminals. Specifically, in a case where a state of movements is “stopping” or “walking”, two terminals may be determined as accompanying together when the distance between the two terminals is less than 20 m as mentioned above. On the other hand, in a case where a state of movements is “on a train”, motion vectors of two terminals may be calculated. In this case, two terminals may be determined as accompanying together in a case where the difference between the magnitudes of the motion vectors (movement distances) is less than 30 m and also the difference between the directions (directions of movements) of the motion vectors is less than 22.5 degrees in each of both sides in a case where the positions of the terminals are measured at intervals of 15 seconds, for example. It is noted that a determination of the state of movement may be determined as follows. For example, in a case where the movement distance of the terminal is less than 10 m in a case where the position of the terminal is measured at intervals of 15 seconds, the terminal is determined as “stopping”; in a case of equal to or more than 10 m and less than 30 m, the terminal is determined as “walking”; and in a case of equal to or more than 30 m, the terminal is determined as “on a train”, for example.

As a further another method of the accompanying determination, there is a method of paying attention to a point that changes in movements of two terminals are likely to be the same in a case where the users of the two terminals act together. In this method, each terminal has an acceleration sensor, and a change in a movement of each terminal is detected by monitoring the output of the acceleration sensor. In this method, the position of one terminal measured when the movement of the terminal is changed and the position of the other terminal measured when the movement of the other terminal is changed are compared, and the distance between the two terminals is calculated. Then, in a case where the calculated distance is equal to or less than a threshold, the two terminals are determined as accompanying together.

Further, in the case of this method, among users of respective terminals, information for identifying a group of users having a relationship is previously registered, and two terminals may be determined as accompanying together only in a case where the uses of the terminals have the relationship. That is, in this case, although the distance between the two terminals is equal to or less than a threshold, the two terminals are determined as not accompanying together in a case where the users of the two terminals do not have the relationship. As examples of the relationship between users, “colleagues at work”, “family”, or such may be cited.

Returning to the description of FIG. 4, in step S118, it is determined whether any terminal(s) accompanying the terminal having transmitted the position information exist as a result of the accompanying determination process of step S117. When no terminal exists (step S118 NO), the process is finished. When any terminal(s) exist (step S118 YES), the server 200 then carries out step 5119.

In step S119, the associating information is registered. That is, for the accompanying terminal(s) obtained from steps S117 and S118 and the terminal having transmitted the position information, a common group ID is given, and these terminals are registered in the associating information DB 216. Thus, these accompanying terminals are associated with one another.

Next, in step S120, the notification timing is calculated. A method of calculating the notification timing will be described later with reference to FIGS. 20A through 20C. Next, in step S121, one of the terminals associated together in step S119 is taken, the calculated notification timing is transmitted thereto, and the server 200 then carries out step S122. In step S122, the server 200 determines whether the notification timing has been transmitted in step S121 to each of all the terminals associated together in step S119. In a case where the notification timing has been transmitted to each of all the associated terminals (step S122 YES), the process is finished. On the other hand, in a case where the notification timing has not been transmitted to each of all the terminals associated in step S119 yet (step S122 NO), the server 200 again carries out step S121.

Next, with reference to FIG. 5, the accompanying cancellation determination process will be described.

First, in step S131, accompanying terminals and not-accompanying terminals are extracted. That is, the terminals for which the above-mentioned accompanying cancellation forecast is being carried out are classified into accompanying terminals and not-accompanying terminals. Thus, the accompanying cancellation determination process is carried out. In the accompanying cancellation determination process, the position information DB 215 is read, and the positions indicated by the respective position information of all the terminals for which the above-mentioned accompanying cancellation forecast is being carried out are compared with each other. Then, in a case where, for example, one terminal thereof is away from each of all the other terminals by equal to or more than a certain distance, the accompanying of the one terminal is determined as having been cancelled. The one terminal thus determined as the accompanying having been cancelled is the above-mentioned not-accompanying terminal. Thus, all the terminals for which the above-mentioned accompanying cancellation forecast is being carried out are classified into accompanying terminals and not-accompanying terminals. Then, the server 200 carries out step S132.

In step S132, the notification timing is calculated. That is, in a case where not-accompanying terminal(s) exist in step S131, the number of the accompanying terminals is reduced as a result of the not-accompanying terminal(s) being removed from the accompanying terminals. Then, the notification timings of the remaining accompanying terminals will be again calculated as a result. On the other hand, in a case where any not-accompanying terminal does not exist in step S131, the number of the accompanying terminals is not changed, and therefore, the notification timings of the accompanying terminals are not again calculated.

Next, in the steps starting from step S133, the notification timings thus calculated in step S132 are transmitted to the respective ones of the accompanying terminals. It is noted that as mentioned above, in a case where any not-accompanying terminal does not exist in step S131, the notification timings of the accompanying terminals are not again calculated. Therefore, in this case, notifications of the notification timings are not carried out. As to the not-accompanying terminal(s), the notification timing(s) (i.e., the original notification timing(s)) in the state where the terminal(s) are not the accompanying terminals, or such, are transmitted thereto.

In step S133, one of the accompanying terminals and not-accompanying terminals both extracted in step S131 is taken, the notification timing is transmitted thereto in step S134, and the server 200 then carries out step S135. In step S135, the server 200 determines whether the notification timing has been transmitted in step S133 to each of all the accompanying and not-accompanying terminals extracted in step S131. In a case where the notification timing has been transmitted to each of all the accompanying and not-accompanying terminals extracted in step S131 (step S135 YES), the process is finished. On the other hand, in a case where the notification timing has not been transmitted to each of all the accompanying and not-accompanying terminals extracted in step S131 yet (step S135 NO), the server 200 again carries out step S133.

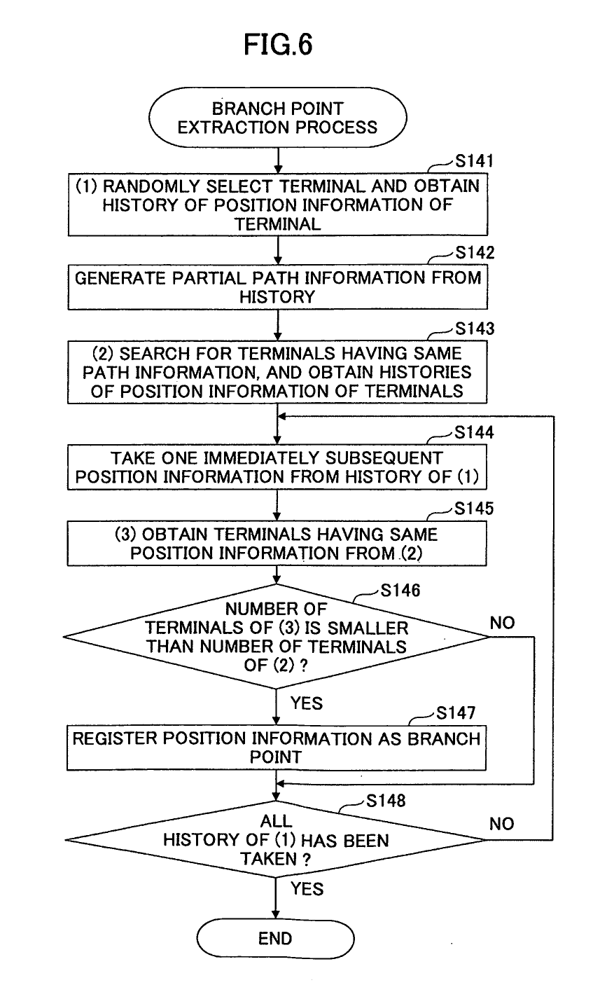

Next, a branch point extraction process will be described with reference to FIG. 6. The branch point extraction process is a process of obtaining the branch point information that is then previously registered in the branch point information DB 218.

In FIG. 6, in step S141, the server 200 reads the position information DB 215, selects a terminal randomly, and obtain the history of the position information of the selected terminal. Next, in step S142, the server 200 obtains a partial path (path information) of the terminal from the obtained history of the position information. Next, in step S143, other terminals each having path information indicating the path the same as the path indicated by the path information obtained in step S142 are searched for from the position information DB 215. Then, the histories of the position information of the other terminals obtained through the search are obtained.

Next, in step S144, from the history of the position information of the terminal obtained in step S141, the position information indicating the position immediately after the path indicated by the path information generated in step S142 is taken. Next, in step S145, the terminal having the position information the same as the position information taken in step S144 is searched for from the terminals obtained in step S143 through the search. Next, in step S146, it is determined whether the number of the terminals taken in step S145 through the search is smaller than the number of the terminals taken in step S143 through the search. In a case where the number of the terminals taken in step S145 through the search is smaller than the number of the terminals taken in step S143 through the search (step S146 YES), the server 200 then carries out step S147.

In step S147, the server 200 registers the branch point information that is the above-mentioned position information taken in step S144 as a branch point in the branch point information DB 218. It is noted that the state where the number of the terminals taken in step S145 through the search is smaller than the number of the terminals taken in step S143 through the search means that as to the terminals by which the number of the terminal thus becomes smaller, the position information becomes not coincident with that of the other terminals. That is, the paths of the terminals by which the number of the terminals becomes smaller are regarded as having been branched, in the data of the histories. That is, the terminal selected in step S141 and the terminals searched for in step S143 have the position information coincident with each other at least in the range of the path indicated by the path information generated in step S142. Therefore, in the determination of step S146, the position at which the position information becomes not coincident in the path after the range in which the position information is coincident is obtained, and the obtained position is registered as the branch point.

On the other hand, in a case where the number of the terminals taken in step S145 through the search is coincident with the number of the terminals taken in step S143 through the search (step S146 NO), it is determined that the path has not been branched yet, and the server 200 then carries out step S148. In step S148, it is determined whether all of the position information that is included in the history of the position information of the terminal selected in step S141 and indicates the positions after the path indicated by the path information generated in step S142 has been taken.

In a case where all of the position information that is included in the history of the position information of the terminal selected in step S141 and indicates the positions after the path indicated by the path information generated in step S142 has not been taken yet (step S148 NO), the server 200 again carries out step S144. In step S144 in this case, the position information indicating the position, next to (immediately after) the position that is immediately after the path indicated by the path information generated in step S142 and has been taken in step S144 at the last time, is taken. Then, for the thus-taken position information, steps S145 and S146 are carried out again. In a case where the determination result of step S146 is still NO and the determination result of step S148 is still NO, step S144 is again carried out. At this time in step S144, the position information indicating the position, further next to (immediately after) the position that is after the path indicated by the path information generated in step S142 and has been taken in step S144 at the immediately preceding time, is taken. Then, for the thus-taken position information, steps S145 and S146 are carried out again. Thus, the branch point of the path is searched for.

In a case where all of the position information that is included in the history of the position information of the terminal selected in step S141 and indicates the positions after the path indicated by the path information generated in step S142 has been taken (step S148 YES), the server 200 finishes the process. However, at this time, the server 200 may return to step S141, select another terminal randomly, obtain the history of the position information of the other terminal and again carry out the steps starting from step S142 for the obtained history of the position information. As a result, it is possible to enrich the contents of the branch point information to be previously registered in the branch point information DB 214. Further, for the same terminal selected in step S141, partial path information different from the path information having been generated in step S142 at the last time may be generated from the history of the position information in step S142 at the current time, and the steps starting from step S143 may be carried out again for the currently generated path information. As a result, it is possible to enrich the contents of the branch point information to be previously registered in the branch point information DB 214.

Further, as the branch point information to be previously registered in the branch point information DB 214, other than the branch point information obtained according to FIG. 6, it is also possible to obtain positions of branch points and/or intersections of roads based on map information, and use these positions as the branch points of the branch point information to be previously registered in the branch point information DB 214.

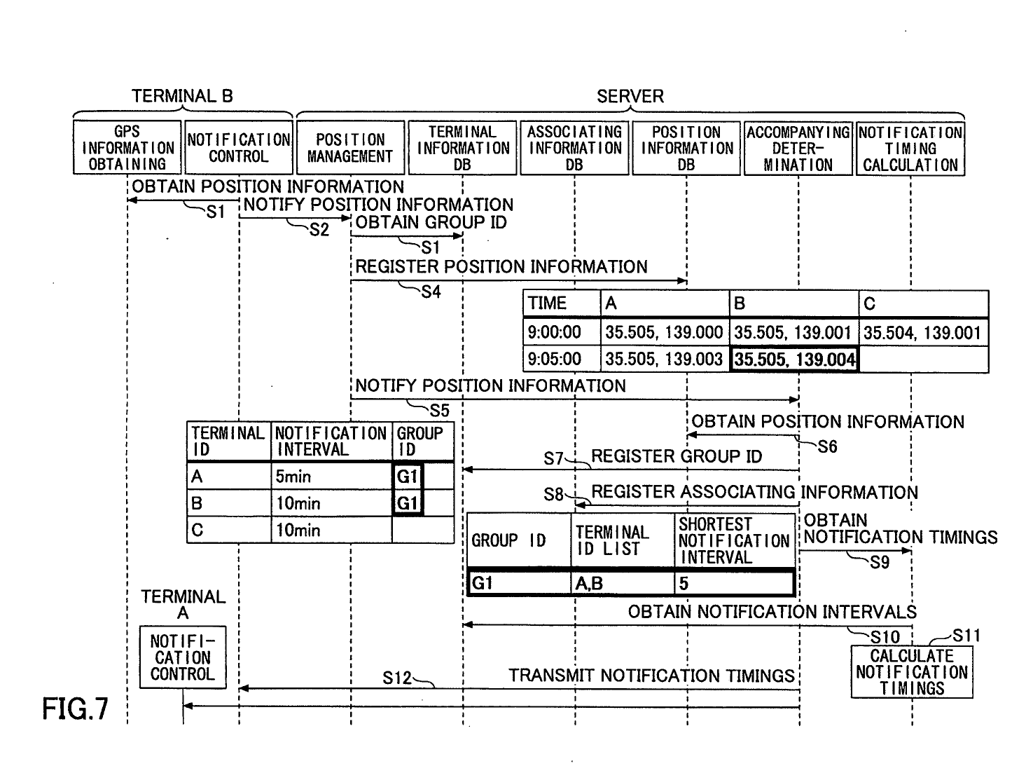

Next, with reference to FIGS. 7 through 19, as an example of embodying the service providing method according to the embodiment 1, an example of flows of operations of the accompanying determination process, the branch point extraction process, the accompanying cancellation forecast process, the accompanying cancellation determination process and so forth for three terminals A, B and C, for example, will be described.

FIG. 7 is a sequence diagram illustrating one example of operations of the accompanying determination process for a case where the terminal A and the terminal B accompany together. It is noted that in the example of FIG. 7, the position information of the terminal A has been already notified to the server 200.

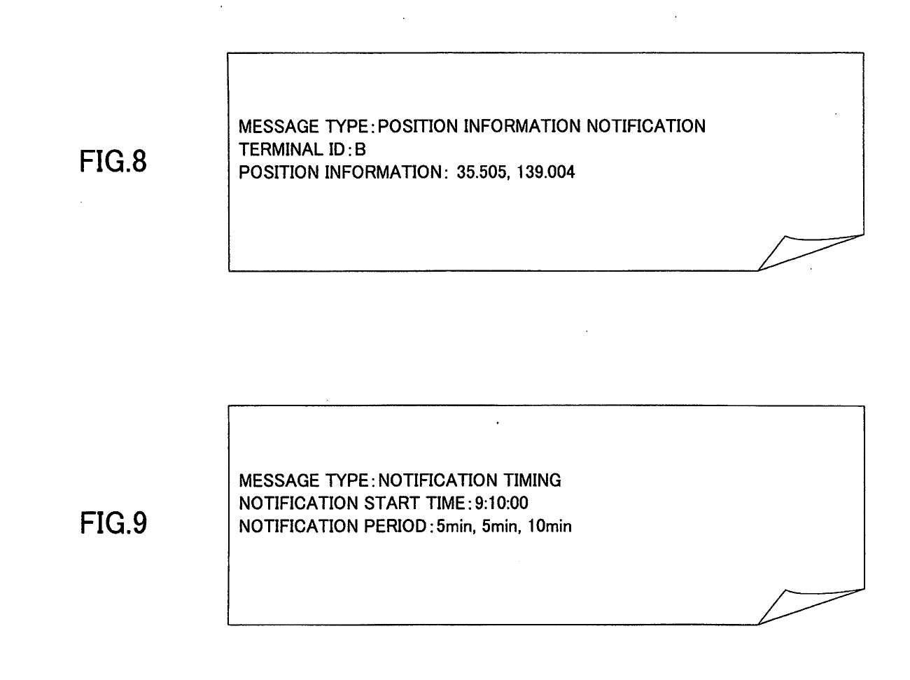

In FIG. 7, in step S1, the notification control part 112 of the terminal B obtains the position information from the GPS information obtaining part 111, and then in step S2, the terminal B notifies the position management part 211 of the server 200 of the obtained position information. FIG. 8 depicts one example of a position information notification message by which the terminal B transmits the position information to the server 200. As depicted in FIG. 8, the position information notification message has respective information of a message type “position information notification”, a terminal ID “B” and the value of the position information.

The message type of the message thus received by the server 200 is not an “accompanying-cancellation-determination position information notification message” (i.e., the position information notification message for an accompanying cancellation determination) (see FIG. 17). Therefore, in FIG. 3, the process progresses as steps S101→S102→S106.

Accordingly, the position management part 211 of the server 200 obtains from the terminal information DB 217 the group ID of the terminal B having transmitted the received position information (step S106 in FIG. 3). It is noted that the terminal B has not been determined as an accompanying terminal yet at this time, and therefore, the terminal B does not actually have the group ID. Therefore, the position management part 211 cannot obtain the group ID of the terminal B.

Next, in step S4, the position management part 211 registers the position information received from the terminal B in the position information DB 215 (step S107 in FIG. 3). Next, in step S5, the position management part 211 notifies the accompanying determination part 212 of the received position information of the terminal B (step S108 in FIG. 3).

Next, in step S6, the accompanying determination part 212 obtains the history of the position information of the terminal B from the position information DB 215 (step S111 in FIG. 4). It is noted that in this case, it is assumed that the branch point information cannot be obtained (step S113 NO), and therefore, step S117 is carried out next. Further, in this case, the accompanying determination part 212 determines the immediately preceding path of the terminal B from the obtained history of the position information. Further, the accompanying determination part 212 reads the position information DB 215, and searches for a terminal having the same immediately preceding path as the determined path of the terminal B (step S117 in FIG. 4).

In the example of FIG. 7, the terminals A and B have the same path. That is, when the position information (latitude and longitude) of the respective ones of the terminals A and B at the time 9:00:00 and the time 9:05:00 after 5 minutes is compared with one another, the longitude has not been changed as 35.505. The latitude has been changed as 139.000→139.003 for the terminal A and 139.001→139.004 for the terminal B. Thus, between the terminals A and B, only the last digit differs by “1” at each time, and thus, the terminals A and B are determined to have the same path. Therefore, the terminals A and B are determined as accompanying together (step S118 YES in FIG. 4). It is noted that in FIG. 7, according to the terminal information DB 217, the notification interval of the terminal A is 5 minutes and the notification interval of each of the terminals B and C is 10 minutes. However, for the sake of convenience of explanation, as to the registered information in the position information DB 215, it is assumed that the notification interval of each of the terminals A, B and C is 5 minutes. That is, the position information of each of the terminals A, B and C is notified at intervals of 5 minutes (and after the accompanying determination, the position information is used as being common, and the position information is obtained by the server 200 also at intervals of 5 minutes).

Next, in step S7, the accompanying determination part 212 registers in the terminal information DB 217 the group ID (G1) of the terminals A and B thus having been determined as accompanying together as mentioned above. Next, in step S8, the accompanying determination part 212 registers in the associating information DB 216 the group ID (G1) and the IDs of the respective terminals A and B belonging to the group of the group ID (G1) (step S119 in FIG. 4).

Next, in step S9, the accompanying determination part 212 sends the terminal IDs (A, B) of the accompanying terminals A and B to the notification timing calculation part 213, and asks the notification timing calculation part 213 to calculate the notification timings. Next, in step S10, the notification timing calculation part 213 obtains the notification intervals of the accompanying terminals A and B from the terminal information DB 217, and calculates the notification timings of the accompanying terminals in step S11 (step S120 in FIG. 4). Then, the notification timing calculation part 213 notifies the calculated notification timings to the accompanying determination part 212.

Next, in step S12, the accompanying determination part 212 transmits the notified notification timings to the notification control parts 112 of the respective accompanying terminals A and B (steps S121→S122 in FIG. 4). FIG. 9 depicts an example of a notification timing message for transmitting the notification timing. In the example of FIG. 9, the notification timing message includes respective information of a message type: “notification timing”; a notification start time “9:10:00”; and notification periods “5 min, 5 min, 10 min”. Therefore, in this example, the terminal having received the message notifies the position information at 9:10:00 (notification start time), and further notifies the position information after 5 minutes, further after 5 minutes and further after 10 minutes. After that, the terminal repeats the notifying operations at intervals of 5 minutes, 5 minutes and 10 minutes. Such a mode of notifying the position information may be referred to as a notification mode.

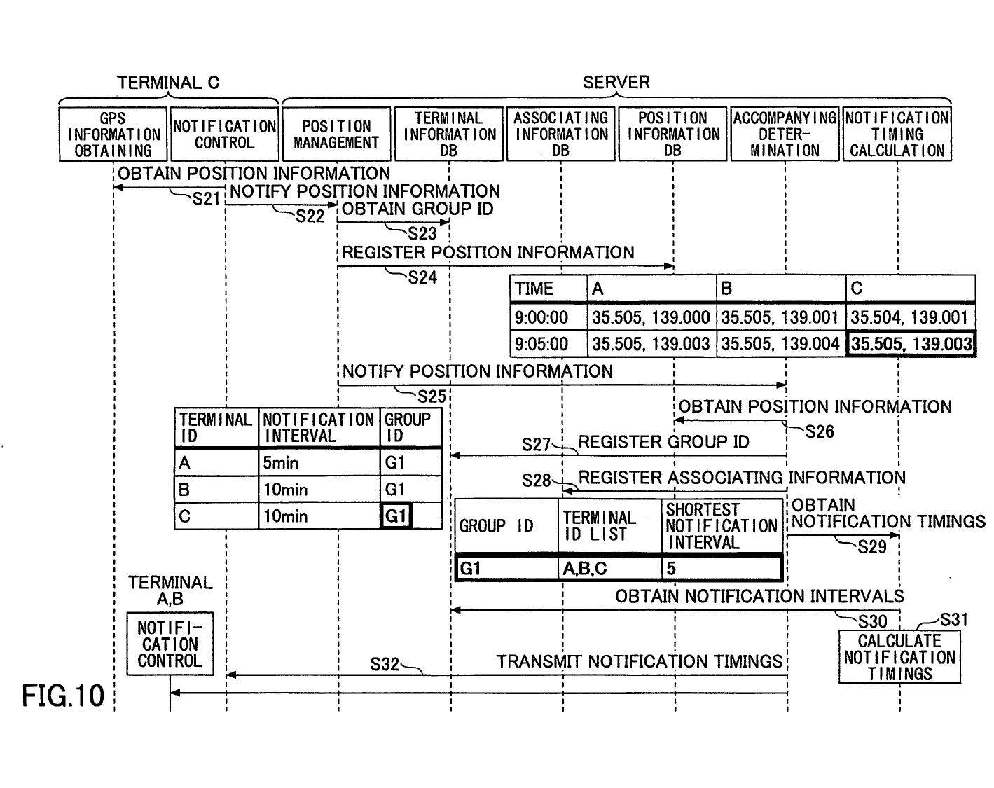

FIG. 10 is a sequence diagram illustrating an example of operations of the accompanying determination process for a case where further the terminal C accompanies the terminals A and B.

In FIG. 10, in step S21, the notification control part 112 of the terminal C obtains the position information from the GPS information obtaining part 111. Then, in step S22, the terminal C transmits the obtained position information to the position management part 211 of the server 200. Also in this case, the message type of the received message is not “accompanying-cancellation-determination position information notification message” (i.e., the position notification message for an accompanying cancellation determination). Therefore, in FIG. 3, the process progresses as steps S101→S102→S106.

Therefore, in step S23, the position management part 211 of the server 200 obtains the group ID of the terminal C having transmitted the received position information from the position information DB 217 (step S106 in FIG. 3). It is noted that the terminal C does not have the group ID yet at this time since the terminal C has not been determined as an accompanying terminal yet. Therefore, the position management part 211 cannot actually obtain the group ID of the terminal C in step S23.

Next, in step S24, the position management part 211 registers the position information notified by the terminal C in the position information DB 215 (step S107 in FIG. 3). Next, in step S25, the position management part 211 notifies the accompanying determination part 212 of the received position information of the terminal C (step S108 in FIG. 3).

Next, in step S26, the accompanying determination part 212 obtains the history of the position information of the terminal C from the position information DB 215 (step S111 of FIG. 4). Also in this case, it is assumed that the accompanying determination part 212 cannot obtain the branch point information in step S112 of FIG. 4 (step S113 NO), and therefore carries out step S117.

Further, in this case, the accompanying determination part 212 determines the immediately preceding path of the terminal C from the obtained history of the position information of the terminal C. Further, the accompanying determination part 212 reads the position information DB 215, and searches for a terminal having the same immediately preceding path as the determined immediately preceding path of the terminal C (step S117 of FIG. 4). In the example of FIG. 10, each of the terminals A and B has the same path as that of the terminal C. That is, when the respective position information (longitude and latitude) of the terminals A, B and C at the time of 9:00:00 and 9:05:00 after 5 minutes is compared with each other, the longitude of the terminals A and B has not changed as 35.505. Only the longitude of the terminal C has changed from 35.504 to 35.505, and therefore, the state where the last digit is different by “1” has changed to the state where the terminal C has the same value as those of the terminals A and B. As to the latitude, 139.000→139.003 for the terminal A; 139.001→139.004 for the terminal B; and 139.001→139.003 for the terminal C. Thus, at each time, merely the last digit is different by “1”, it can be determined that the terminals A, B and C have substantially the same path, and thus, the terminals A, B and C are determined as accompanying together (step S118 YES in FIG. 4).

Next, in step S27, the accompanying determination part 212 registers the group ID (G1) of the accompanying terminals A, B and C. It is noted that at this time, as for the terminals A and B, the group ID (G1) has been already registered as mentioned above. Therefore, the accompanying determination part 212 may obtain the group ID (G1) already registered for the terminals A and B, and register the obtained group ID (G1) also as the terminal C. Alternatively, the accompanying determination part 212 may newly obtain a group ID for the terminals A, B and C, and register the obtained group ID. At this time, for the terminals A and B, the newly obtained group ID may be registered in an overwriting manner.

Next, in step S28, the accompanying determination part 212 registers in the associating information DB 216 the group ID (G1) and the respective IDs of the terminals A, B and C belonging to the group of the group ID (G1) (step S119 of FIG. 4).

Next, in step S29, the accompanying determination part 212 sends the terminal IDs of the accompanying terminals A, B and C to the notification timing calculation part 213, and requests the notification timing calculation part 213 to calculate the notification timings of the accompanying terminals A, B and C. Next, in step S30, the notification timing calculation part 213 obtains the notification intervals of the accompanying terminals A, B and C from the terminal information DB 217, and calculates the notification timings of the accompanying terminals A, B and C in step S31 (step S120 in FIG. 4). Then, the notification timing calculation part 213 notifies the accompanying determination part 212 of the calculated notification timings.

Next, in step S32, the accompanying determination part 212 transmits the notified notification timings to the notification control parts 112 of the respective accompanying terminals A, B and C (the loop of steps S121, S122 of FIG. 4).

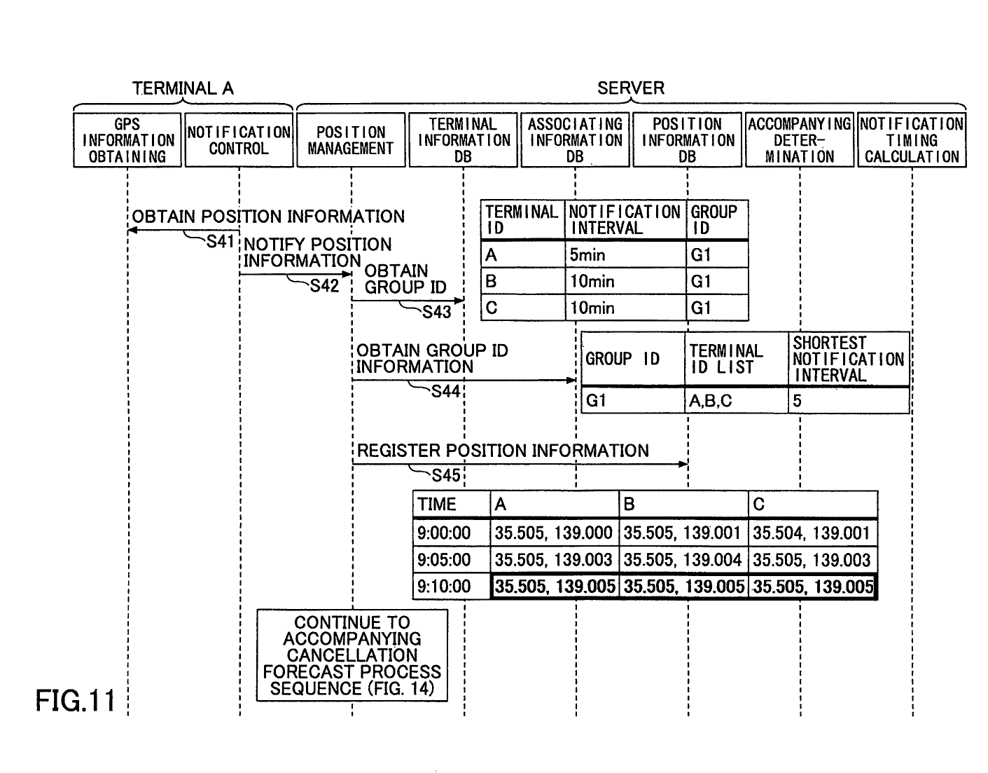

Next, with reference to FIG. 11, an example of a flow of a process for a case where in the state where the terminals A, B and C are accompanying together, the position information is notified by the terminal A.

In step S41, the notification control part 112 of the terminal A obtains the position information from the GPS information obtaining part 111, and then, in step S42, the notification control part 112 notifies the position management part 211 of the server 200 of the obtained position information. Next, in step S43, the position management part 211 of the server 200 receives the notification of the position information (step S101 YES in FIG. 3). After that, the position management part 211 of the server 200 obtains the group ID of the terminal A having transmitted the received position information from the terminal information DB 217 (step S102 NO→step S106 in FIG. 3). In this case, as mentioned above, the terminal A is the accompanying terminal together with the terminals B and C, and thus, the group ID (G1) can be actually obtained.

Next, in step S44, since the position management part 211 has obtained the group ID of the terminal A in step S43, the position management part 211 obtains the list of the terminal IDs (A, B, C) belonging to the above-mentioned group ID (G1) from the associating information DB 216. The position management part 211 further obtains the shortest one (the shortest notification interval) of the respective notification intervals of these terminals A, B and C (step S106 in FIG. 3). In this case, the shortest notification interval is 5 minutes.

Next, in step S45, the position management part 211 uses the received position information of the terminal A as being common as the position information of the respective ones of the terminals A, B and C, and registers the position information in the position information DB 215 (step S107 in FIG. 3). Next, the accompanying cancellation forecast process of FIG. 14 is started.

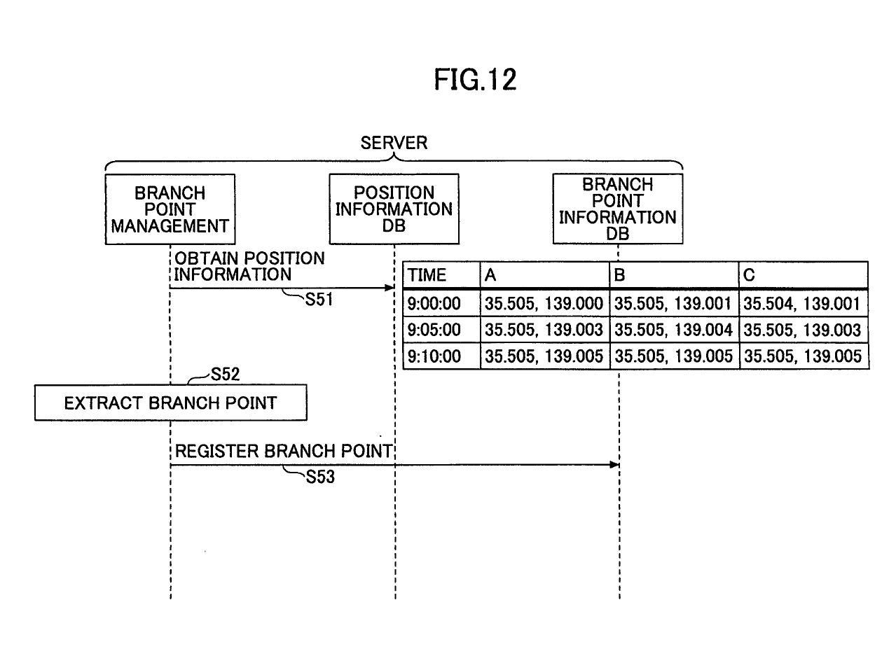

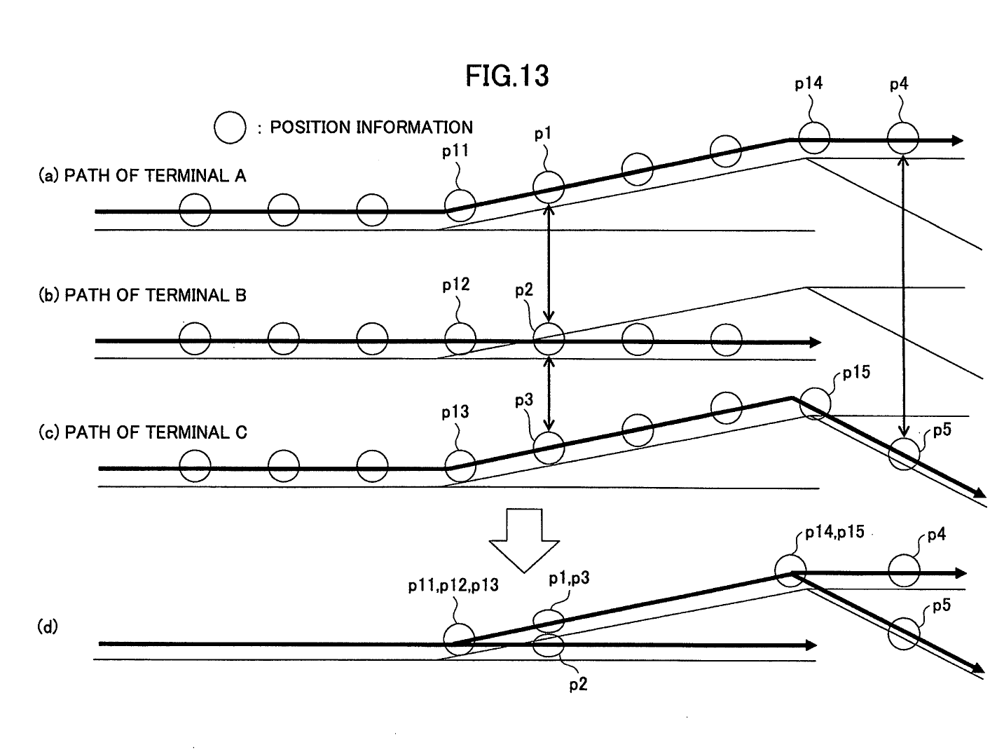

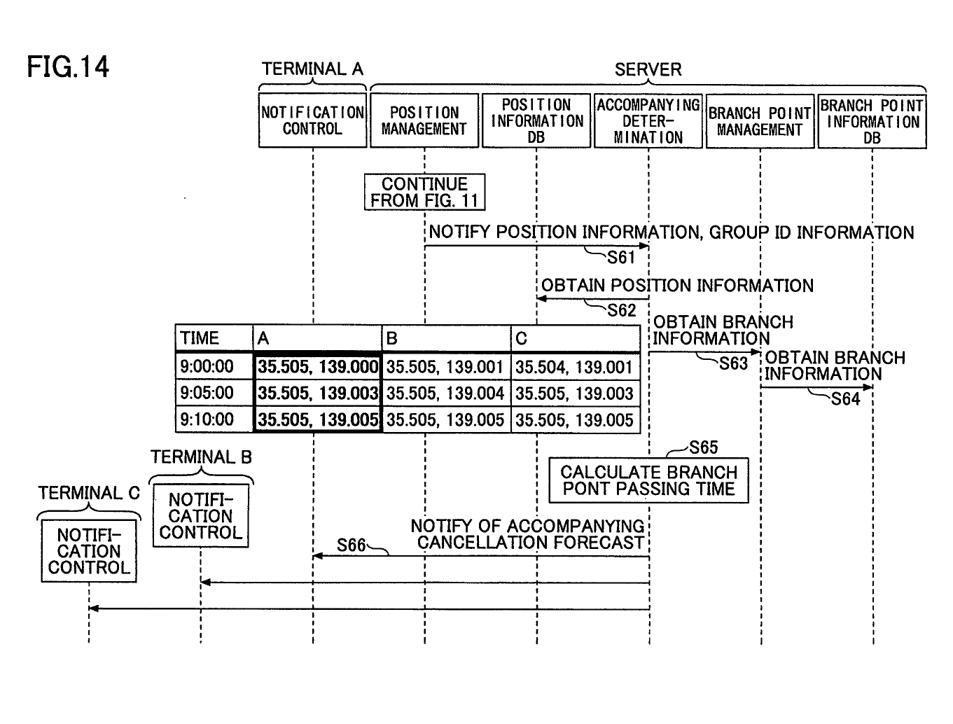

With reference to FIGS. 12 and 13, another example of the branch point extraction process described above with reference to FIG. 6 will now be described.

In FIG. 12, in step S51, the branch point management part 214 of the server 200 obtains the histories of the position information of the plural terminals (in the example of FIG. 12, the terminals A, B and C) from the position information DB 215. Next, in step S52, the branch point management part 214 generates the paths (path information) from the obtained histories of the position information, and extracts the branch point from the generated paths of the plural terminals. Next, step S53 is carried out.

With reference to FIG. 13, an example of the branch point extraction process of generating the paths from the histories of the plural terminals and extracting the branch point at which the paths branch will be described.

In FIG. 13, (a), a bold line denotes the path of the terminal A obtained from the position information DB 215. Fine lines denote, for example, roads. It is noted that actually, the path (bold line) of the terminal A lies on the road (fine line). However, for the sake of convenience of explanation, the path (bold line) is depicted as slightly shifting upward from the road (fine line) in FIG. 13, (a)

Similarly, in FIG. 13, (b), a bold line denotes the path of the terminal B obtained from the position information DB 215. Similarly, in FIG. 13, (c), a bold line denotes the path of the terminal C obtained from the position information DB 215. In FIG. 13, (d), the respective paths of the terminals A, B and C depicted in FIG. 13, (a), (b) and (c), respectively, are depicted on the common coordinate plane.

As depicted in FIG. 13, the paths of the terminals A, B and C are coincident with each other up to the positions p11, p12 and p13. Then, at the positions p1, p2 and p3, the path of the terminal B is separated from the paths of the terminals A and C. Further, at the positions p4 and p5, then, the paths of the terminals A and C are separated from one another. In this example, in a case where the paths of the plural terminals become away from one another by a certain distance or more, the position immediately before the position at which the paths become away from one another by the certain distance or more is referred to as the branch point, for example. Therefore, in the case of FIG. 13, assuming that the positions p1 and p3 of the terminals A and C are away from the position p2 of the terminal B by the certain distance or more, the positions p11, p12 and p13 immediately before the positions p1, p2 and p3 are the branch point. Similarly, assuming that the positions p4 and p5 of the terminals A and C are away from each other by the certain distance or more, the positions p14 and p15 immediately before the positions p4 and p5 are the branch point.

Thus, positions included in the respective paths of the plural terminals (A, B and C) are compared with each other along the paths. Then, in the history data, a position at which positions included in the respective paths are separated by the certain distance or more is found out after a path part exists where positions included in the respective paths have less than the certain distance therebetween. Then, the position immediately before the position at which the positions included in the respective paths are separated by the certain distance or more may be obtained as the branch point.

In step S53, the information of the thus-obtained branch point (the branch point information) is registered in the branch point information DB 218 by the branch point management part 214.

Next, with reference to FIG. 14, an example of operations of the accompanying cancellation forecast process will be described. The operations of FIG. 14 are carried out after the operations of FIG. 11, and are the example for a case where the position information has been notified by the terminal A.

In FIG. 14, in step S61, the position management part 211 of the server 200 sends the position information obtained in step S42 of FIG. 11 from the terminal A and information concerning the group ID (including the list of the terminal IDs and the shortest notification interval of the accompanying terminals) obtained in step S44 to the accompanying determination part 212.

Next, in step S62, the accompanying determination part 212 obtains the histories of the position information of the accompanying terminals included in the sent list of the terminal IDs of the accompanying terminals from the position information DB 215 (step S111 of FIG. 4). Then, the accompanying determination part 212 obtains the moving speeds and the moving directions of the accompanying terminals based on the histories of the position information of the accompanying terminals.

Next, in step S63, the accompanying determination part 212 uses the position information of the current position, the moving speed and the moving direction of the terminal A and the shortest notification interval of the accompanying terminals, and requests the branch point management part 214 to obtain the branch point information. The branch point management part 214 obtains the branch point information from the branch point information DB 218 based on the above-mentioned information (the position information of the current position, the moving speed and the moving direction of the terminal A and the shortest notification interval of the accompanying terminals), and notifies the accompanying determination part 212 of the obtained branch point information in step S64 (step S112, step S113 YES in FIG. 4). In this case, based on the above-mentioned information, the branch point management part 214 searches the branch point information DB 218 for the branch point information of the branch point at which the terminal A is expected to pass through until the next notification timing of the shortest notification interval, and notifies the accompanying determination terminal 212 of the branch point information obtained through the search.

Further, the accompanying determination part 212 determines whether there is a terminal associated with the terminal A (step S114 in FIG. 4). In this case, since the terminal A is the accompanying terminal together with the terminals B and C, the associated terminals (B and C) exist (step S114 YES).

Next, in step S65, based on the branch point information obtained from the branch point management part 214 and the position information of the current position and the moving speed of the terminal A, the accompanying determination part 212 calculates the time at which it is expected that the terminal A passes through the branch point indicated by the branch point information. Next, in step S66, the accompanying determination part 212 transmits the accompanying cancellation forecast notification messages, instructing the terminals to notify their position information at the time after the calculated time at which the terminal A (and also the other accompanying terminals B and C since they are accompanying together) is expected to pass through the branch point, to the respective one of the accompanying terminals A, B and C (the loop of step S115 and S116 in FIG. 4).

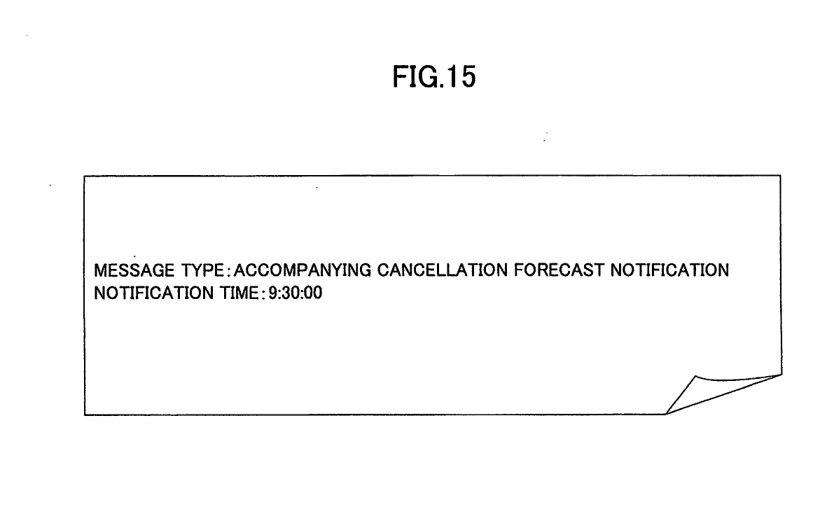

FIG. 15 depicts an example of the accompanying cancellation forecast notification message. In the example of FIG. 15, the accompanying cancellation forecast message includes respective information of the message type “accompanying cancellation forecast notification” and the notification time. In the case of this example, the accompanying cancellation forecast notification message instructs the accompanying terminals to notify the position information at the notification time “9:30:00” (half past nine) (the after the time at which it is expected that the accompanying terminals pass through the branch point).

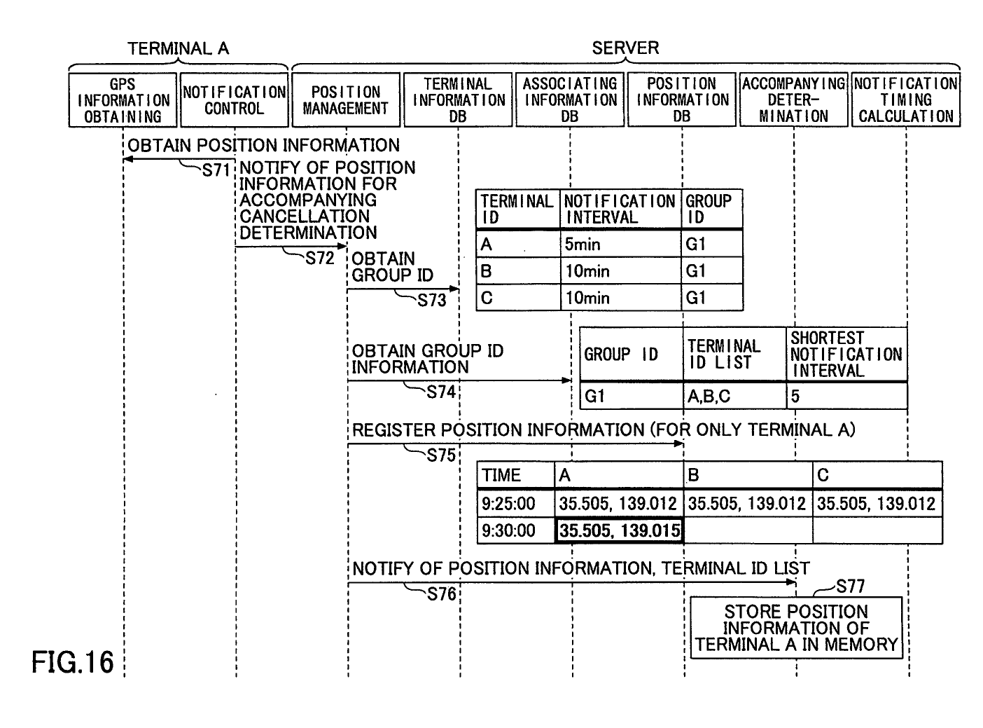

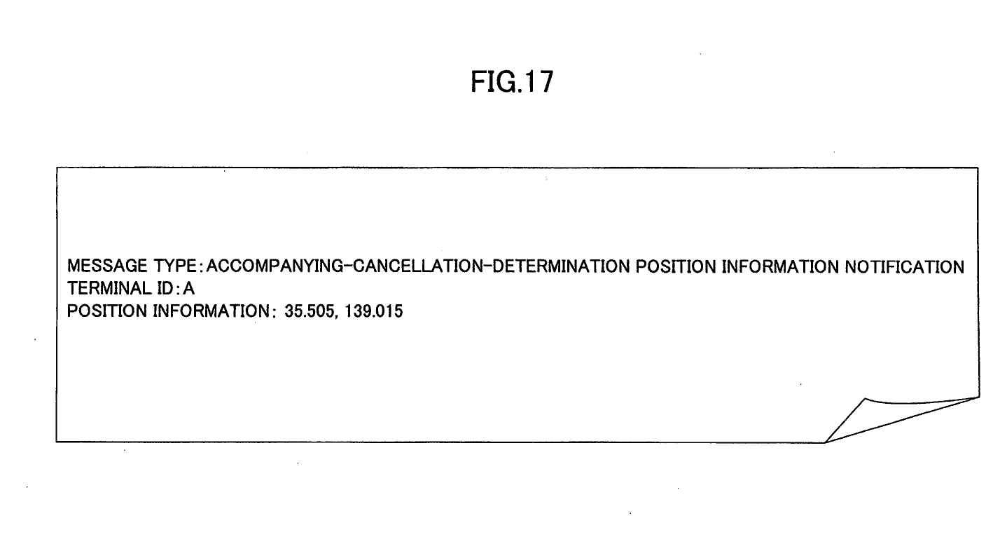

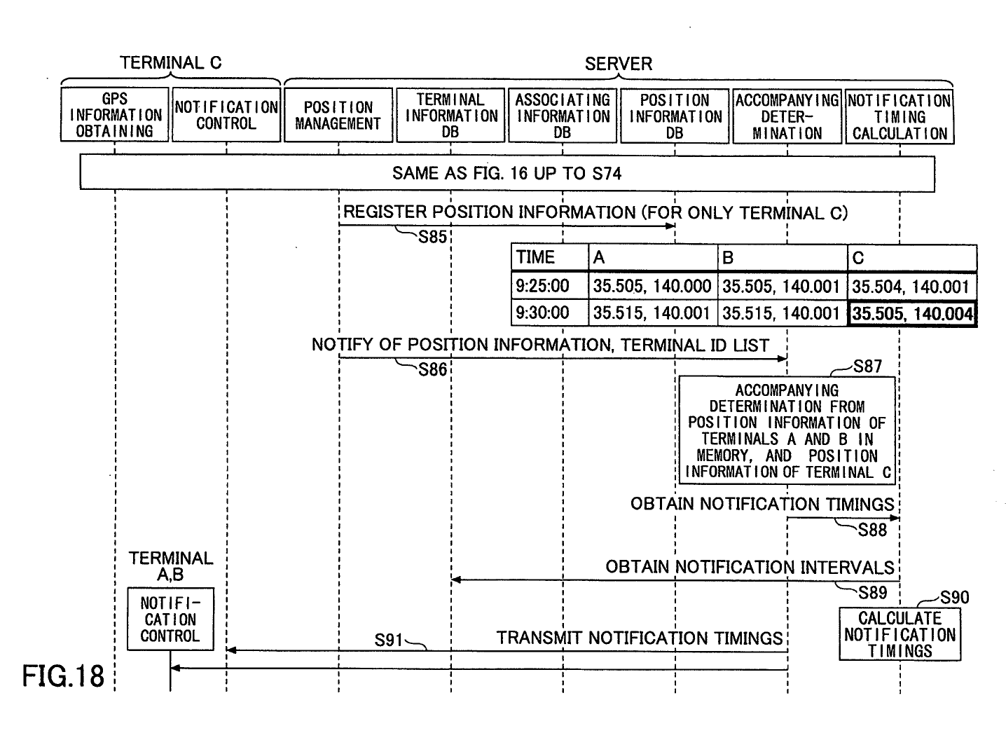

Next, with reference to FIGS. 16 through 19, an example of operations of the accompanying cancellation determination process described above with reference to FIG. 5 will be described.

FIG. 16 depicts an example of operations carried out by the server 200 after the terminal A notifies the server 200 of the position information for an accompanying cancellation determination in response to the accompanying cancellation forecast notification message, and the server 200 receives the notification. It is noted that at this time, the position information for an accompanying cancellation determination has not been notified by any of the other accompanying terminals B and C.

In FIG. 16, in step S71, the notification control part 112 of the terminal A obtains the position information from the GPS information obtaining part 111 at half past nine (9:30) that is the above-mentioned notification time, and in step S72, the notification control part 112 uses the obtained position information and notifies the position management part 211 of the server 200 of the position information for an accompanying cancellation determination.

FIG. 17 depicts one example of the position information notification message for an accompanying cancellation determination. In the example of FIG. 17, the position information notification massage for an accompanying cancellation determination includes respective information of the message type “accompanying-cancellation-determination position information notification”, the terminal ID and the position information.

Next, in step S73, the position management part 211 of the server 200 obtains the group ID of the terminal A from the terminal information DB 217. In this case, the group ID (G1) of the accompanying terminals A, B and C are obtained.

Next, in step S74, the position management part 211 obtains the list of the terminal IDs of the terminals (the accompanying terminals A, B and C) having the group ID (G1) from the associating information ID 216. There, A, B and C as the terminal IDs of the accompanying terminals A, B and C are obtained.

Next, in step S75, the position management part 211 registers the position information of the terminal A in the position information DB 215, and in step S76, the position management part 211 sends the position information of the terminal A and the list of the terminal IDs of the accompanying terminals to the accompanying determination part 212.

Next, in step S77, the accompanying determination part 212 stores the position information of the terminal A in the memory 202, and also, determines whether the current position information of each of all the accompanying terminals (A, B and C) included in the sent list of the terminal IDs is stored in the memory 202. In this case, as mentioned above, the position information has not been notified by any one of the other accompanying terminals B and C yet. Therefore, it is not determined that the current position information of each of all the accompanying terminals (A, B and C) included in the sent list of the terminal IDs is stored in the memory 202. Therefore, in this case, an accompanying cancellation determination is not carried out.

FIG. 18 depicts an example of operations carried out by the server 200 when the server 200 receives the notification of the position information for an accompanying cancellation determination (accompanying-cancellation-determination position information notification) from the terminal C after the position information for an accompanying cancellation determination has been notified by the terminals A and B. It is noted that after the operations of FIG. 16 and before the operations of FIG. 18, the position information for an accompanying cancellation determination is notified by the terminal B and the server 200 carries out the operations for the terminal B similar to those of FIG. 16.

In the case of FIG. 18, the process the same as steps S71 through S74 of FIG. 16 is carried out for the terminal C. That is, the notification control part 112 of the terminal C obtains the position information from the GPS information obtaining part 111 at half past nine (9:30) (notification time), and notifies the position management part 211 of the sever 200 of the obtained position information as the position information for an accompanying cancellation determination. Next, the position management part 211 of the server 200 obtains the group ID of the terminal C from the terminal information DB 217. In this case, the group ID (G1) of the accompanying terminals A, B and C is obtained. Next, the position management part 211 obtains the list of the terminal IDs of the terminals (the accompanying terminals A, B and C) belonging to the obtained group ID (G1) from the associating information DB 216. In this case, A, B and C are obtained as the terminal IDs of the accompanying terminals.

Next, in step S85, the position management part 211 registers the position information of the terminal C in the position information DB 215, and, in step S86, the position management part 211 sends the position information of the terminal C and the list of the terminal IDs of the accompanying terminals to the accompanying determination part 212.

Next, in step S87, the accompanying determination part 212 carries out an accompanying cancellation determination using the information stored in the memory 202 (step S131 of FIG. 5), since in this case, it is determined that the current position information of each of all the accompanying terminals (A, B and C) included in the sent list of the terminal IDs is stored in the memory 202.

In the case of the example of FIG. 18, with reference to the position information at the time “9:30:00” (half past nine), each of the terminals A and B has the same longitude and latitude as “35.515” and “140.001”. On the other hand, the terminal C has longitude and latitude as “35.505” and “140.004”. Thus, in comparison to the position information of the terminals A and B, the last two digits are different by “10” and “03”, respectively. In this state, it is assumed that only the terminal C is determined to have entered a state of not accompanying the terminals A and B. That is, at this time, the terminals A and B are still accompanying together, but only the terminal C is determined as not accompanying any one of the terminals A and B. Such a terminal as the terminal C at this time which is not accompanying any one of the other terminals may be referred to as a not-accompanying terminal.

The accompanying cancellation determination is such that, for example, in a case where one of mutually accompanying terminals has come to have a distance from any one of the other terminals which distance is equal to or more than a certain distance, it may be determined that the accompanying of the one terminal for the remaining terminals has been cancelled.

It is noted that other than the above-mentioned method of the accompanying cancellation determination, it is also possible to use the following method. That is, the accompanying determination (accompanying determination process) described above is carried out, and it may be determined that the accompanying has been cancelled when the requirement(s) for determining the accompanying has(have) come to be not fulfilled.

Further, as another method of the accompanying cancellation determination, the following method may be used. That is, when a first terminal of plural mutually accompanying terminals has come to not fulfill the requirement(s) for determining the accompanying only for any second terminal of the remaining terminals, it may be determined that the accompanying of the first terminal has been cancelled only for the second terminal. In this case, on the other hand, it may be determined that the accompanying of the first terminal for the remaining terminals other than the second terminal is still maintained, as long as the requirement(s) for determining the accompanying of the first terminal for each of the remaining terminals other than the second terminal is still fulfilled. For example, suppose that terminals A, B and C have been accompanying together. Then, the requirement(s) for determining the accompanying of the terminal A for the terminal B is still fulfilled, but the requirement(s) for determining the accompanying of the terminal A for the terminal C becomes not fulfilled. In this case, either one of two cases may occur. In one of the two cases, the terminals A and B are accompanying together, while the terminal C is a not-accompanying terminal and is not accompanying any one of the terminals A and B. In the other of the two cases, the terminals A and B are accompanying together, while the terminal C is not accompanying the terminal A but is still accompanying the terminal B. In the latter case, the accompanying relationship between the terminals A and B and the accompanying relationship between the terminals B and C exist individually. Even in such a case, the terminals A, B and C may be determined as still accompanying together, and the position information may be used as being common to the terminals A, B and C.

Next, in step S88 of FIG. 18, the accompanying determination part 212 sends the terminal IDs of the accompanying terminals A and B to the notification timing calculation part 213, and requests the notification timing calculation part 213 to calculate the notification timings. Then, in step S89, the notification timing calculation part 213 uses the sent terminal IDs of the accompanying terminals A and B, and obtains the notification intervals of the accompanying terminals A and B from the terminal information DB 217. Then in step S90, the notification timing calculation part 213 calculates the notification timings using the obtained notification intervals of the accompanying terminals to calculate the notification timings of the accompanying terminals A and B, and notifies the accompanying determination part 212 of the calculated notification timings (step S132 of FIG. 5).

Next, in step S91, the accompanying determination part 212 may transmit to the not-accompanying terminal C the notification timing of the original notification interval so that the terminal C returns the own notification interval to the original notification interval that has been used before becoming the accompanying terminal together with the terminals A and B. On the other hand, the accompanying determination part 212 transmits the notification timings of the accompanying terminals A and B notified in step S90 to the notification control parts 112 of the respective ones of the accompanying terminals A and B.

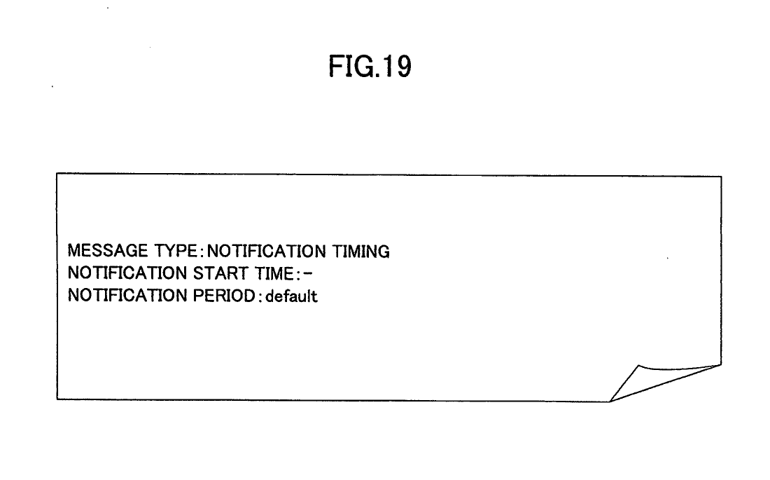

FIG. 19 denotes an example of the notification timing message that transmits the notification timing of the original notification interval so that the terminal (such as the terminal C) becoming the not-accompanying terminal from the accompanying terminal returns its own notification interval to the original one. In the example of FIG. 19, the notification timing message includes respective information of the message type “notification timing”, the notification start time and the notification period (notification interval). However, in this case, as depicted in the figure, particularly designating the notification start time may be omitted. That is, the not-accompanying terminal may start using the original notification interval from when receiving the notification timing message.

Further, in the example of FIG. 19, as the notification period, information of “default” is notified. That is, in this case, the notification control part 112 of the not-accompanying terminal holds the information of the original notification interval (notification period) at the state of not being an accompanying terminal. Then, when receiving the notification timing message having the information of “default”, the notification control part 112 may carry out control such as to start using the original notification interval based on the held information of the original notification interval. Alternatively, the notification timing message is not limited to the example of FIG. 19, and instead, as the information of the notification period of the notification timing message, the specific value of the period of time indicating the actual original notification interval may be notified.

Next, with reference to FIGS. 20A, 20B and 20C, examples of a method of calculating the notification timings calculated by the notification timing calculation part 213 will be described.

The notification timing is calculated based on the notification interval (in the state where the terminal is not an accompanying terminal) of each of the accompanying terminals. More specifically, the ratio of the reciprocals of the (original) notification intervals of the respective ones of the accompanying terminals are defined as a ratio of the numbers of times of collection. The number of times of collection means an average number of times of notifications per a certain time period, and is also referred to as a notification frequency. Then, according to the ratio of the numbers of times of collection (first requirement) and the shortest notification interval (second requirement), the notification timings of the respective ones of the accompanying terminals are determined.

As one example, it is assumed that the (original) notification intervals of the respective ones of terminals A, B and C are 5 minutes, 10 minutes and 10 minutes. In this case, the ratio of the numbers of times of collection is the ratio of the reciprocals of the notification intervals, and thus, is 1/5:1/10:1/10=2:1:1. Further, the shortest notification intervals of 5 minutes, 10 minutes and 10 minutes is 5 minutes. FIG. 20A depicts an example of the notification timings of the accompanying terminals A, B and C determined by the notification timing calculation part 213 according to the ratio of the numbers of times of collection (first requirement) and the shortest notification interval (second requirement).

In FIG. 20A, the bottom line depicts the elapse of time in units of 5 minutes, and the top line depicts the notification timing of the terminal A. The second line depicts the notification timing of the terminal B and the third line depicts the notification timing of the terminal C. In FIG. 20A, the symbol “◯” denotes the notification timing of notifying the position information.

In the example of FIG. 20A, in the first 20 minutes, the terminal A carries out notifications twice, and each of the terminals B and C carries out notification once. Thus, the ratio of the numbers of times of collection is 2:1:1, and thus, the first requirement is met. Further, any one of the terminals A, B and C carries out notification of the position information in turn at intervals of 5 minutes, i.e., the shortest notification interval. Thus, also the second requirement is met. After that, as depicted in FIG. 20A, every 20 minutes, the same pattern of notification where the terminal A carried out notification twice and any one of the terminals B and C carries out notification once is repeated.

According to the notification timings of the example of FIG. 20A, when, for example, the terminal A is focused on, the notification timings are 5 minutes, 10 minutes, 25 minutes, 30 minutes, 45 minutes, 50 minutes, . . . . Thus, the notification frequency is twice every 20 minutes. On the other hand, since the (original) notification interval is 5 minutes, the (original) notification frequency is four (4) times every 20 minutes. Thus, the notification frequency of the terminal A is reduced from four times every 20 minutes to twice every 20 minutes. Thus the notification frequency becomes ½ (half). As a result, the power consumption of the terminal A for carrying out measurement of the position and notification of the position information is reduced, and also, the network load for notification of the position information is reduced.

Further, among the accompanying terminals A, B and C, as mentioned above, the position information is used as being common to the terminals A, B and C. As a result, in each of the timings of, for example, 15 minutes and 20 minutes where notification of the position information from the terminal A is not carried out but instead any one of the terminals B and C carries out notification of the position information, the server 200 can use the position information notified by any one of the terminals B and C also as the position information of the terminal A. Therefore, even when using the notification timings of FIG. 20A, the server 200 can obtain the position information every 5 minutes the same as the original notification interval of 5 minutes, for the terminal A. That is, at the time intervals the same as the (original) notification intervals, the server 200 obtains the position information of the terminal A (or the position information that is regarded as the position information of the terminal A). Therefore, while the time intervals at which the server 200 obtains the position information of the terminal A are maintained, the power consumption of the terminal A can be reduced, and the network load can be reduced.

Similarly, according to the notification timings in the example of FIG. 20A, when the terminals B and C are focused on, the notification timings are 15 minutes, 35 minutes, 55 minutes, . . . , or 20 minutes, 40 minutes, 60 minutes, . . . . Thus, the notification frequency is once every 20 minutes. On the other hand, the (original) notification interval of each of the terminals B and C is 10 minutes, and the (original) notification frequency is twice every 20 minutes. Thus, the notification frequency of each of the terminals B and C is reduced from twice every 20 minutes into once ever 20 minutes, and thus, becomes ½ (half). As a result, the power consumption of each of the terminals B and C for carrying out measurement of the position and notification of the position information is reduced, and also, the network load for notification of the position information is reduced.

Further, as mentioned above, the position information is used as being common to the accompanying terminals A, B and C. As a result, in each of the timings of, for example, 5 minutes, 10 minutes and 20 minutes where notification of the position information from the terminal B is not carried out but instead any one of the terminals A and C carries out notification of the position information, the server 200 can use the position information notified by any one of the terminals A and C also as the position information of the terminal B. Similarly, in each of the timings of, for example, 5 minutes, 10 minutes and 15 minutes where notification of the position information from the terminal C is not carried out but instead any one of the terminals A and B carries out notification of the position information, the server 200 can use the position information notified by any one of the terminals A and B also as the position information of the terminal C.

Therefore, even when using the notification timings of FIG. 20A, the server 200 obtains the position information every 5 minutes for the terminal B or C. That is, at the time intervals 5 minutes shorter than the (original) notification intervals 10 minutes, the server 200 obtains the position information of the terminal B or C (or the position information that is regarded as the position information of the terminal B or C). Therefore, while the time intervals at which the server 200 obtains the position information of the terminals B and C are maintained (or improved), the power consumption of the terminal B and C can be reduced, and the network load can be reduced.

It is noted that the pattern of the notification timings of the respective ones of the terminals A, B and C is not limited to the example of FIG. 20A. That is, as long as the ratio of the numbers of times of collection of the accompanying terminals A, B and C, i.e., 2:1:1 is maintained (first requirement) and also any one of the terminals A, B and C carries out notification of the position information in turn every 5 minutes, i.e., the shortest notification interval (second requirement), other various patterns of notification timings may be used, instead.

As another example, a description will now be made for a case where the (original) notification intervals of the respective ones of the terminals A, B and C are 5 minutes, 11 minutes and 16 minutes, respectively. FIG. 20B depicts an example of a pattern of the notification timings calculated by the notification timing calculation part 213 for this example. In the case of this example, different from the above-mentioned example (the (original) notification intervals of the terminals A, B and C are 5 minutes, 10 minutes and 10 minutes, respectively), each of the (original) notification intervals of the respective terminals is not a multiple of the shortest notification interval, i.e., 5 minutes. In such a case, the notification interval of each terminal is divided by the shortest notification interval, the fraction below the decimal point of the obtained quotient is omitted, and each of the thus-obtained respective values is multiplied by the shortest notification interval. Then, the thus-obtained values are used to obtain a ratio of the numbers of times of collection.

In this case, the notification intervals of the terminals A, B and C are 5 minutes, 11 minutes and 16 minutes, respectively, as mentioned above. Then, the shortest notification interval 5 minutes is used to divide each of them, and the fraction below the decimal point is omitted. Thus, 1, 2 and 3 are obtained. Further, the shortest notification interval (5 minutes) is used to multiply them, and as a result, 5 [minutes], 10 [minutes] and 15 [minutes] are obtained.

Next, the same as the above-mentioned example, the ratio of the reciprocals of the obtained 5 minutes, 10 minutes and 15 minutes is obtained. As a result, the ratio of the numbers of times of collection is obtained as 1/5:1/10:1/15=6:3:2. FIG. 20B depicts an example of a pattern of the notification timings such that, the same as the above-mentioned example, the obtained ratio of the numbers of times of collection of 6:3:2 is to be maintained (first requirement) and also any one of the terminals is to carry out notification of the position information in turn at intervals of 5 minutes, i.e., the shortest notification interval (second requirement). In the example of FIG. 20B, during 55 minutes, the terminal A carries out notification of the position information six times, the terminal B carries out notification of the position information three times and the terminal C carries out notification of the position information twice. Thus, the ratio of the numbers of times of collection is 6:3:2, and thus, the first requirement is met. Further, as depicted in FIG. 20B, any one of the terminals carries out notification of the position information in turn at intervals of 5 minutes, i.e., the shortest notification interval. Thus, also the second requirement is met.

FIG. 20C is a flowchart depicting a flow of one example of a method of obtaining a pattern of the notification timings such as that depicted in FIG. 20A or 20B by arithmetic and logic operations. Operations of FIG. 20C is carried out by the notification timing calculation part 213.

In FIG. 20C, in step S151, the (original) notification intervals of accompanying terminals are obtained. Next, in step S152, the shortest one (shortest notification interval) of the obtained notification intervals is obtained. Next, in step S153, the notification interval of each terminal is divided by the shortest notification interval, the fraction below the decimal point of each of the thus-obtained quotients is omitted, and each of the thus-obtained values is multiplied by the shortest notification interval.

Next, in step S154, the ratio of the reciprocals of the respective values obtained in step S153 is obtained. Next, in step S155, the respective values of the obtained ratio (the ratio of the numbers of times of collection) are added together, and the thus-obtained value is multiplied by the shortest notification interval. Thus, the cycle period is obtained.

The cycle period means a value obtained from multiplying the number of times of notification included in the pattern of the notification timings of the accompanying terminals by the shortest notification interval. The pattern of the notification timings will now be described. For example, in the case of FIG. 20A, a pattern of the notification timings is repeated where every 20 minutes, at intervals of 5 minutes, the terminal A successively carries out notification twice, then each of the terminals B and C carries out notification once in sequence. Such a repeated pattern is referred to as a pattern of the notification timings. In the case of FIG. 20A, the pattern of the notification timings is a pattern of 20 minutes, the number of times of notification included in the pattern of 20 minutes is 4 [times], and the cycle period is obtained from 4 [times]×5 [min] (=20 [min]). On the other hand, in the case of the example of FIG. 20B, the pattern of the notification timings is a pattern of 55 minutes, the number of times of notification included is 11 [times], and the cycle period is obtained from 11 [times]×5 [min] (=55 [min]).

Returning to the description of FIG. 20C, next, in step S156, in each time of the number of times of notification included in the obtained cycle period, a respective one of the notification timings of the respective terminals is allocated in the above-mentioned ratio of numbers of times of notification. Next, in step S157, the operation in step S156 is repeated.

It is noted that as an example of a method of allocating in step S156, it is possible to use a method where allocating is carried out randomly with such weights that the notification timings of the respective terminals occur with probabilities in proportion to the ratio of the number of times of collection (first requirement). Alternatively, as another method, the numbers of times in proportion to the ratio of the number of times of collection may be allocated successively to each terminal in turn. For example, in the example of FIG. 20B, in the 11 times (the number of times of notification) included in the cycle period, the first six times may be allocated to the terminal A, the next three times may be allocated to the terminal B and the remaining two times may be allocated to the terminal C. As a result, at intervals of 5 minutes, the notification timings are allocated to the terminals A, A, A, A, A, A, B, B, B, C, C in the stated order. Also in this case, the ratio of the numbers of times of collection of 6:3:2 is met.

When the example of FIG. 20B is applied to the flowchart of FIG. 20C, the notification intervals 5 minutes, 11 minutes and 16 minutes of the terminals A, B and C are obtained (step S151), and the shortest notification interval (5 minutes) is obtained (step S152).

Then, each of the notification intervals of the respective terminals A, B and C is divided by the shortest notification interval, and the fraction below the decimal point of each quotient is omitted. Thus, 1, 2 and 3 are obtained, and then, the shortest notification interval is used to multiply each of 1, 2 and 3. Thus, 5 [minutes], 10 [minutes] and 15 [minutes] are obtained (step S153). Further, the ratio of the reciprocals of the obtained values is obtained as 1/5:1/10:1/15=6:3:2 (step S154).

Then, the respective values of the obtained ratio are added together as 6+3+2=11. The thus-obtained value “11” is multiplied by 5 [min], and thus, the cycle period (55 [min]) is obtained (step S155). Then, in respective times of the 11 times included in the cycle period, the notification timings of the terminals A, B and C are allocated in the ratio of the numbers of times of collection (6:3:2) (step S156). As a result, the pattern of the notification timings as the example of FIG. 20B is obtained, for example. Alternatively, as another example, as mentioned above, the notification timings may be allocated in the stated order of the terminals A, A, A, A, A, A, B, B, B, C, C. After that, the same allocation is repeated (step S157).

### Embodiment 2

A service providing method according to an embodiment 2 of the present invention will now be described.

The service providing method according to the embodiment 2 has a configuration approximately the same as the service providing method according to the embodiment 1 described above, description will be made for different points between the two embodiments 1 and 2, and duplicate description will be omitted as is appropriate.

In the case of the embodiment 2, each terminal 100 notifies the server 200 of a battery remaining amount in addition when notifying the position information, and the notification timing calculation part 213 of the server 213 considers the notified battery remaining amounts of the respective terminals, and calculates the notification timings of the accompanying terminals.

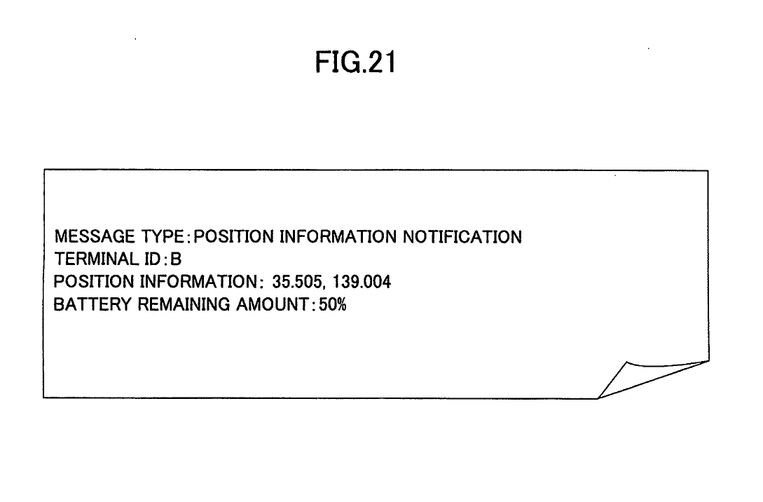

More specifically, in step S2 in FIG. 7, the notification control part 112 of the terminal B notifies the position management part 211 of the server 200 of the position information and the battery remaining amount. The battery remaining amount is transmitted to the server 200 via the communication part 103 after the power supply part 105 obtains the battery remaining amount of the battery 106, under the control of the CPU 101. FIG. 21 depicts one example of the position information notification message in the case of the embodiment 2.

In the example of FIG. 21, the position information notification message includes respective information of the message type “position information notification”, the terminal ID, the position information and the battery remaining amount.

In step S5 in FIG. 7, the position management part 211 sends the notified position information and battery remaining amount of the terminal B to the accompanying determination part 212. Further, in step S9, the accompanying determination part 212 sends the information of the terminal IDs (A, B) and the battery remaining amounts of the accompanying terminals A and B to the notification timing calculation part 213, and requests the notification timing calculation part 213 to calculate the notification timings.

Next, one example of a method of calculating the notification timings considering the battery remaining amounts of the accompanying terminals according to the embodiment 2 will be described. In this case, the notification timing calculation part 213 calculates the notification timings of the respective accompanying terminals based on the (original) notification intervals and the battery remaining amounts of the respective ones of the accompanying terminals. More specifically, what is different from the embodiment 1 is that the notification timings of the respective ones of the accompanying terminals are calculated according to the ratio obtained from multiplying the respective values of the ratio of the numbers of times of collection of the respective ones of the accompanying terminals by the respective values of the ratio of the battery remaining amounts of the respective ones of the accompanying terminals, respectively.

For example, in the case where the (original) notification intervals of the terminals A, B and C are 5 minutes, 10 minutes and 10 minutes, respectively, the ratio of the numbers of times of collection is, the ratio of the reciprocals of the notification intervals the same as in the embodiment 1, i.e., 1/5:1/10:1/10=2:1:1. Further, assuming that the battery remaining amounts of the terminals A, B and C are 100%, 100% and 50%, respectively, the ratio of the battery remaining amounts is 100:100:50=2:2:1. Then, when the respective values of the ratio of the numbers of times of collection (2:1:1) are multiplied by the respective values of the ratio of the battery remaining amounts (2:2:1), respectively, 2×2:1×2:1×1=4:2:1 is obtained. The thus-obtained ratio 4:2:1 is the ratio of the numbers of times of collection considering the battery remaining amounts.

Then, in the case of the embodiment 2, the notification timings are determined such that the requirement of the ratio of the numbers of times of collection considering the battery remaining amounts is met (first requirement) and also any one of the accompanying terminals carries out notification of the position information in turn at intervals of the shortest notification interval (second requirement).

FIG. 22A depicts one example of the thus-determined pattern of the notification timings. In the case of this example, from the above-mentioned ratio of the numbers of times of collection considering the battery remaining amounts of 4:2:1, the respective values of the ratio are added together as 4+2+1=7, and then, the cycle period is obtained from multiplying the thus-obtained value by the shortest notification interval of 5 minutes as 7×5=35 [min]. It is noted that since the notification intervals of the terminals A, B and C are 5 minutes, 10 minutes and 10 minutes, respectively, as mentioned above, the shortest notification interval is 5 minutes. In the case of the example of FIG. 22A, the pattern of 35 minutes (=5 [minutes]×7 [times]) is the pattern of the notification timings, and in the pattern of the notification timings of 35 minutes, the terminals A, B and C carry out notification 4 times, 2 times and 1 time, respectively (thus, according to the above-mentioned ratio of the numbers of times of collection considering the battery remaining amounts) (first requirement), and also, any one of the accompanying terminals A, B and C carries out notification in turn at intervals of the shortest notification interval of 5 minutes (second requirement). Thus, the first requirement (the ratio of the numbers of times of collection of 4:2:1) and the second requirement (shortest notification interval of 5 minutes) are met.

FIG. 22B is a flowchart depicting a flow of one example of a method of obtaining a pattern of the notification timings such as that depicted in FIG. 22A by arithmetic and logic operations, according to the embodiment 2. Operations of FIG. 22B is carried out by the notification timing calculation part 213.

In the flow of FIG. 22B, steps 5151 through S154 are the same as steps S151 through S154 of FIG. 20C, and duplicate description will be omitted.

Step S165 is carried out after step S154. In step S165, the respective values of the ratio of the numbers of times of collection obtained in step S154 are multiplied by the respective values of the ratio of the battery remaining amounts, respectively. Thus, the ratio of the numbers of times of collection considering the battery remaining amounts is obtained. Next, in step S166, the respective values of the obtained ratio (the ratio of the number of times of collection considering the battery remaining amounts) are added together, and the thus-obtained value is multiplied by the shortest notification interval. Thus, the cycle period is obtained.

Next, in step S167, in each time (of the number of times of notification) included in the obtained cycle period, the notification timings of the respective terminals are allocated in the ratio of the numbers of times of collection considering the battery remaining amounts. Next, in step S168, the operation in step S167 is repeated.

It is noted that as an example of a method of allocating in step S167, the same as in the embodiment 1, it is possible to use a method where allocating is carried out randomly with such weights that the notification timings of the respective terminals occur with probabilities in proportion to the ratio of the number of times of collection considering the battery remaining amounts (first requirement). Alternatively, as another method, the same as in the embodiment 1, the numbers of times in proportion to the ratio of the number of times of collection considering the battery remaining amounts may be allocated successively to each terminal in turn. For example, in the example of FIG. 22A, in the 7 times included in the cycle period, the first four times may be allocated to the terminal A, the next two times may be allocated to the terminal B and the remaining one time may be allocated to the terminal C. As a result, at intervals of 5 minutes, the notification timings are allocated to the terminals A, A, A, A, B, B, C in the stated order. Also in this case, the first requirement (the ratio of the numbers of times of collection considering the battery remaining amounts of 4:2:1) and the second requirement (the shortest notification interval of 5 minutes) is met.

When the example of FIG. 22A is applied to the flowchart of FIG. 22B, the notification intervals 5 minutes, 10 minutes and 10 minutes of the respective terminals A, B and C are obtained (step S151), and the shortest notification interval (5 minutes) thereof is obtained (step S152). Then, each of the notification intervals of the respective terminals A, B and C is divided by the shortest notification interval, and the fraction below the decimal point of each of the obtained quotients is omitted. Thus, 1, 2 and 2 are obtained, and then, the shortest notification interval is used to multiply each of 1, 2 and 2. Thus, 5 [minutes], 10 [minutes] and 10 [minutes] are obtained (step S153). Further, the ratio of the reciprocals of the obtained values is obtained as 1/5:1/10:1/10=2:1:1 (step S154).

Then, in step S165, the respective values of the obtained ratio of the numbers of times of collection are multiplied by the respective values of the ratio of the battery remaining amounts of the respective accompanying terminals. Thus, as mentioned above, 2×2:1×2:1×1=4:2:1 is obtained. Next, in step S166, the respective values of the obtained ratio of the numbers of times of collection considering the battery remaining amounts are added together as 4+2+1=7. The thus-obtained value “7” is multiplied by 5 [min], and thus, the cycle period is obtained. Then, in respective times of the 7 times included in the cycle period, the notification timings of the terminals A, B and C are allocated in the ratio of the numbers of times of collection considering the battery remaining amounts (4:2:1) (step S167).

As a result, the pattern of the notification timings as the example of FIG. 22A is obtained, for example. Alternatively, as mentioned above, the notification timings may be allocated in the stated order of the terminals A, A, A, A, B, B, C. After that, the same allocation is repeated (step S168).

In the case of the example of FIG. 22A., the notification frequency of the terminal A is four times every 35 minutes, and thus, is reduced from the original notification frequency of once every 5 minutes (i.e., seven times every 35 minutes). Thus, the notification frequency becomes 4/7 (=0.57 . . . ). The notification frequency of the terminal B is two times every 35 minutes, and thus, is reduced from the original notification frequency of once every 10 minutes (i.e., 3.5 times every 35 minutes). Thus, the notification frequency becomes 2/3.5 (=0.57 . . . ). The notification frequency of the terminal C is one time every 35 minutes, and thus, is reduced from the original notification frequency of once every 10 minutes (i.e., 3.5 times every 35 minutes). Thus, the notification frequency becomes 1/3.5 (=0.28 . . . ).

Thus, especially as for the terminal C having the small battery remaining amount of 50%, the notification frequency is reduced by a larger ratio in comparison to the other terminals A and B. That is, according to the embodiment 2, it is possible to minimize a further reduction of the battery remaining amount by selectively reducing the notification frequency of the terminal having the small battery remaining amount by a larger amount, in addition to the advantageous effects of the embodiment 1.

Thus, the present invention has been described herein with reference to preferred embodiments thereof. While the present invention has been shown and described with particular examples, it should be understood that various changes and modifications may be made to the particular examples without departing from the scope of the broad spirit and scope of the present invention as defined in the claims. That is, the scope of the present invention is not limited to the particular examples and the attached drawings.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. A service providing method of an information processing apparatus being notified of position information by terminals and providing services corresponding to the notified position information of the terminals, the method comprising:
determining movements of the terminals based on the notified position information;
in a case where it has been determined that a difference between the movements of the terminals is equal to or less than a threshold, storing information indicating the determined terminals in an associating information database to be associated with each other;
transmitting signals indicating notification modes of reduced notification frequencies of the position information to the associated terminals, respectively; and
when the position information is notified by one of the associated terminals, using the notified position information as the position information of one of the associated terminals and also as the position information of another one of the associated terminals.

2. The service providing method as claimed in claim 1, wherein
the associated terminals notify their position information at certain notification intervals, respectively, before receiving the signals indicating the notification modes of reduced notification frequencies of the position information, and
the service providing method further comprises determining the notification modes of the reduced notification frequencies of the position information based on certain notification intervals or certain notification intervals and battery remaining amounts of the respective associated terminals such that the number of terminals of the associated terminals which simultaneously notify position information is one.

3. The service providing method as claimed in claim 1, wherein
the associated terminals notify their position information at certain notification intervals, respectively, before receiving the signals indicating the notification modes of reduced notification frequencies of the position information, and
the service providing method further comprises determining by the information processing apparatus notification modes of reduced notification frequencies of the position information such that the time intervals of obtaining the position information at the certain notification intervals from the respective associated terminals can be approximately ensured even in a case where the respective associated terminals notify the position information according to the notification modes of reduced notification frequencies of the position information and the information processing apparatus uses the position information notified by one of the associated terminals as the position information of one of the associated terminals and also as the position information of another one of the associated terminals.

4. The service providing method as claimed in claim 1, further comprising:
determining the notification modes of reduced notification frequencies of the position information by
obtaining a shortest notification interval of the certain notification intervals of the associated terminals,
dividing each of the certain notification intervals of the associated terminals by the shortest notification interval, omitting the fraction below the decimal point of each of the obtained quotients, and multiplying each of the obtained values by the shortest notification interval,
obtaining reciprocals of the respective obtained values, and obtaining a ratio of the respective reciprocals;
adding integers of the obtained ratio together and multiplying the obtained value by the shortest notification interval to obtain a cycle period, and
allocating one of the associated terminals as each of terminals which notifies the position information every interval of the shortest notification interval in the obtained ratio in the cycle period.

5. The service providing method as claimed in claim 1, further comprising:
determining the notification modes of reduced notification frequencies of the position information by
obtaining a shortest notification interval of the certain notification intervals of the associated terminals,
dividing each of the certain notification intervals of the associated terminals by the shortest notification interval, omitting the fraction below the decimal point of each of the obtained quotients, and multiplying each of the obtained values by the shortest notification interval,
obtaining reciprocals of the respective obtained values, and obtaining a ratio of the respective reciprocals,
multiplying integers of the obtained ratio by integers of a ratio of battery remaining amounts of the respective associated terminals, respectively, and obtaining a ratio of the respective obtained values to obtain a ratio considering the battery remaining amounts of the terminals,
adding integers of the ratio considering the battery remaining amounts of the terminals together and multiplying the obtained value by the shortest notification interval to obtain a cycle period, and
allocating one of the associated terminals as each of terminals which notifies the position information every interval of the shortest notification interval in the ratio considering the battery remaining amounts of the terminals in the cycle period.

6. The service providing method as claimed in claim 1, further comprising:
determining based on the position information and histories of the position information of the respective associated terminals, whether a state where the difference between the movements of the associated terminals is equal to or less than the threshold is likely to be cancelled,
carrying out accompanying cancellation forecast notification including notification of a time at which it is expected that the state where the difference between the movements of the associated terminals is equal to or less than the threshold is likely to be cancelled, to the respective terminals, in a case of having determined that the state where the difference between the movements of the associated terminals is equal to or less than the threshold is likely to be cancelled, wherein
each of the respective terminals receiving the accompanying cancellation forecast notification and notifying the information processing apparatus of the position information after the time at which it is expected that the state where the difference between the movements of the associated terminals is equal to or less than the threshold is likely to be cancelled, and
the service providing method further comprising:
using the position information notified by the respective associated terminals after the time at which the state where the difference between the movements of the associated terminals is equal to or less than the threshold is likely to be cancelled, and determining whether the state has been cancelled.

7. An information processing apparatus being notified of position information by terminals and providing services corresponding to the notified position information of the terminals, comprising:
a determination part configured to determine movements of the terminals based on the notified position information, and in a case where it has been determined that a difference between the movements of the terminals is equal to or less than a threshold, storing information indicating the determined terminals in an associating information database in a manner of being associated with each other;
a notification mode obtaining part configured to obtain notification modes of reduced notification frequencies of the position information for the associated terminals, respectively;
a transmission part configured to transmit signals indicating the notification modes obtained by the notification mode obtaining part to the associated terminals, respectively; and
a position information using part configured to use, when being notified of the position information by one of the associated terminals, the notified position information as the position information of the one of the associated terminals and also as the position information of another one of the associated terminals.

8. The information processing apparatus as claimed in claim 7, wherein
the associated terminals are configured to notify their position information at certain notification intervals, respectively, before receiving the signals indicating the notification modes of reduced notification frequencies of their position information, respectively, and
the notification mode obtaining part is configured to determine the notification modes of reduced the notification frequencies of the position information based on certain notification intervals or certain notification intervals and battery remaining amounts of the respective associated terminals such that the number of terminals of the associated terminals which simultaneously notify the position information is one.

9. The information processing apparatus as claimed in claim 7, wherein
the associated terminals are configured to notify the position information at certain notification intervals, respectively, before receiving the signals indicating the notification modes of reduced notification frequencies of the position information, and
the notification mode obtaining part is configured to determine the notification modes of reduced notification frequencies of the position information such that the time intervals of obtaining the position information at the certain notification intervals from the respective associated terminals can be approximately ensured even in a case where the respective associated terminals notify the position information according to the notification modes of reduced notification frequencies of the position information and the information processing apparatus uses the position information notified by one of the associated terminals as the position information of the one of the associated terminals and also as the position information of another one of the associated terminals.

10. The information processing apparatus as claimed in claim 7, wherein
the notification mode obtaining part is configured to determine the notification modes of reduced notification frequencies of the position information by
obtaining a shortest notification interval of the certain notification intervals of the associated terminals,
dividing each of the certain notification intervals of the associated terminals by the shortest notification interval, omitting the fraction below the decimal point of each of the obtained quotients, and multiplying each of the obtained values by the shortest notification interval,
obtaining reciprocals of the respective obtained values, and obtaining a ratio of the respective reciprocals,
adding integers of the obtained ratio together and multiplying the obtained value by the shortest notification interval to obtain a cycle period, and
allocating one of the associated terminals as each of terminals which notifies the position information every interval of the shortest notification interval in the obtained ratio in the cycle period.

11. The information processing apparatus as claimed in claim 7, wherein
the notification mode obtaining part is configured to determine the notification modes of reduced notification frequencies of the position information by
obtaining a shortest notification interval of the certain notification intervals of the associated terminals,
dividing each of the certain notification intervals of the associated terminals by the shortest notification interval, omitting the fraction below the decimal point of each of the obtained quotients, and multiplying each of the obtained values by the shortest notification interval,
obtaining reciprocals of the respective obtained values, and obtaining a ratio of the respective reciprocals,
multiplying integers of the obtained ratio by integers of a ratio of battery remaining amounts of the respective associated terminals, respectively, and obtaining a ratio of the respective obtained values to obtain a ratio considering the battery remaining amounts of the terminals,
adding integers of the ratio considering the battery remaining amounts of the terminals together and multiplying the obtained value by the shortest notification interval to obtain a cycle period, and
allocating one of the associated terminals as each of terminals which notifies the position information every interval of the shortest notification interval in the ratio considering the battery remaining amounts of the terminals in the cycle period.

12. The information processing apparatus as claimed in claim 7, wherein
the determination part is configured to determine based on the position information and histories of the position information of the respective associated terminals whether the state where the difference between the movements of the associated terminals is equal to or less than the threshold is likely to be cancelled,
carry out accompanying cancellation forecast notification including notification of a time at which it is expected that the state where the difference between the movements of the associated terminals is equal to or less than the threshold is likely to be cancelled, to the respective terminals, in a case of having determined that the state where the difference between the movements of the associated terminals is equal to or less than the threshold is likely to be cancelled, and
use the position information which is notified by the respective associated terminals in response to the accompanying cancellation forecast notification after the time at which it is expected that the state where the difference between the movements of the associated terminals is equal to or less than the threshold is likely to be cancelled, and determine whether the state where the difference between the movements of the associated terminals is equal to or less than the threshold has been cancelled.

13. A computer readable information recording medium tangibly embodying a service providing program which, when executed by a computer processor, performs a service providing method of being notified of position information by terminals and providing services corresponding to the notified position information of the terminals, the method comprising:
determining movements of the terminals based on the notified position information;
in a case where it has been determined that a difference between the movements of the terminals is equal to or less than a threshold, storing information indicating the determined terminals in an associating information database in a manner of being associated with each other;
obtaining notification modes of reduced notification frequencies of the position information for the associated terminals;
transmitting signals indicating the obtained notification modes to the associated terminals; and
when the position information is notified by one of the associated terminals, using the notified position information as the position information of the one of the associated terminal and also as the position information of another one of the associated terminals.

14. The computer readable information recording medium as claimed in claim 13, wherein
the associated terminals notify the position information at certain notification intervals, respectively, before receiving the signals indicating the notification modes of reduced notification frequencies of the position information, and
the service providing method further comprises determining the notification modes of reduced notification frequencies of the position information based on the certain notification intervals or the certain notification intervals and battery remaining amounts of the respective associated terminals such that the number of terminals of the associated terminals which simultaneously notify the position information is one.

15. The computer readable information recording medium as claimed in claim 13, wherein
the associated terminals notify the position information at certain notification intervals, respectively, before receiving the signals indicating the notification modes of reduced notification frequencies of the position information, and
the service providing method further comprises determining the notification modes of reduced notification frequencies of the position information such that the time intervals of obtaining the position information at the certain notification intervals from the respective associated terminals can be approximately ensured even in a case where the respective associated terminals notifies the position information according to the notification modes of reduced notification frequencies of the position information and the position information notified by one of the associated terminals is used as the position information of the one of the associated terminals and also as the position information of another one of the associated terminals.

16. The computer readable information recording medium as claimed in claim 13, the service providing method further comprising:
determining the notification modes of reduced notification frequencies of the position information by
obtaining a shortest notification interval of the certain notification intervals of the associated terminals,
dividing each of the certain notification intervals of the associated terminals by the shortest notification interval, omitting the fraction below the decimal point of each of the obtained quotients, and multiplying each of the obtained values by the shortest notification interval,
obtaining reciprocals of the respective obtained values, and obtaining a ratio of the respective reciprocals,
adding integers of the obtained ratio together and multiplying the obtained value by the shortest notification interval to obtain a cycle period, and
allocating one of the associated terminals as each of terminals which notifies the position information every interval of the shortest notification interval in the obtained ratio in the cycle period.

17. The computer readable information recording medium as claimed in claim 13, the service providing method further comprising:
determining the notification modes of reduced notification frequencies of the position information by
obtaining a shortest notification interval of the certain notification intervals of the associated terminals,
dividing each of the certain notification intervals of the associated terminals by the shortest notification interval, omitting the fraction below the decimal point of each of the obtained quotients, and multiplying each of the obtained values by the shortest notification interval,
obtaining reciprocals of the respective obtained values, and obtaining a ratio of the respective reciprocals,
multiplying integers of the obtained ratio by integers of a ratio of battery remaining amounts of the respective associated terminals, respectively, obtaining a ratio of the respective obtained values to obtain a ratio considering the battery remaining amounts of the terminals,
adding integers of the ratio considering the battery remaining amounts of the terminals together and multiplying the obtained value by the shortest notification interval to obtain a cycle period, and
allocating one of the associated terminals as each of terminals which notifies the position information every interval of the shortest notification interval in the ratio considering the battery remaining amounts of the terminals in the cycle period.

18. The computer readable information recording medium as claimed in claim 13, the service providing method further comprising:
determining based on the position information and histories of the position information of the respective associated terminals whether the state where the difference between the movements of the associated terminals is equal to or less than the threshold is likely to be cancelled,
carrying out accompanying cancellation forecast notification including notification of a time at which it is expected that the state where the difference between the movements of the associated terminals is equal to or less than the threshold is likely to be cancelled, to the respective terminals, in a case of having determined that the state where the difference between the movements of the associated terminals is equal to or less than the threshold is likely to be cancelled, wherein
each of the respective terminals receives the accompanying cancellation forecast notification and notifies the position information after the time at which it is expected that the state where the difference between the movements of the associated terminals is equal to or less than the threshold is likely to be cancelled, and
the service providing method further comprising:
using the position information notified by the respective associated terminals after the time at which it is expected that the state where the difference between the movements of the associated terminals is equal to or less than the threshold is likely to be cancelled, and determining whether the state where the difference between the movements of the associated terminals is equal to or less than the threshold has been cancelled.
